(19) United States
(12) Patent Application Publication
(10) Pub. No.: US 2005/0175762 A1
(43) Pub. Date: Aug. 11, 2005

(54) Methods and compositions to inhibit lipid oxidation

(76) Inventors: Mark P. Richards, Madison, WI (US); Chen-Hsien Lee, Madison, WI (US); Jess D. Reed, Middleton, WI (US)

Correspondence Address: QUARLES & BRADY LLP, FIRSTAR PLAZA, ONE SOUTH PINCKNEY STREET, P.O. BOX 2113 SUITE 600, MADISON, WI, 53701-2113, US

(21) Appl. No.: 10/971,317

(22) Filed: Oct. 22, 2004

Related U.S. Application Data
(60) Provisional application No. 60/513,837, filed on Oct. 23, 2003.

(51) Int. Cl. A23C 1/00

(52) U.S. Cl. 426/601

(57) ABSTRACT

The invention relates to methods and compositions for the inhibition of lipid oxidation in food products susceptible to lipid oxidation. The invention provides natural lipophilic antioxidant compositions extracted from fruit used for use in a variety of products to inhibit lipid oxidation. Also, disclosed herein are methods using the natural lipophilic antioxidants extracted from fruit to reduce food spoilage and extend shelf life in food products susceptible to lipid oxidation.

### CROSS-REFERENCE TO RELATED APPLICATIONS

This application claims the benefit of U.S. Provisional Application No. 60/513,837 filed Oct. 23, 2003, which is hereby incorporated by reference herein.

### STATEMENT REGARDING FEDERALLY SPONSORED RESEARCH OR DEVELOPMENT

This invention was made with United States Government support awarded by the following agencies: USDA/CSREES Grant No. 03-CRHF-0-6055. The United States has certain rights in this invention.

### BACKGROUND OF THE INVENTION

Lipid oxidation is a major source of quality deterioration in foods. Odor, flavor, texture, color and nutritional value are negatively affected by lipid oxidation. Many food products (e.g., ground or minced meat products and fish products) are manufactured using muscle tissue of high lipid content or by adding fat to improved product texture. The higher the fat content of a food, the greater the concern that the lipids in the food will oxidize. In particular, it has been found that the membrane or polar lipids can cause unpleasant colors and odors in the food. Thus oxidative rancidity leads to the qualitative deterioration of muscle foods, resulting in the production of unpalatable flavor and odor, thereby resulting in a shortened shelf life. One means of preventing or decreasing lipid oxidation (measured by the production of thiobarbituric acid reactive substances (TBARS)) is to add an antioxidant, typically having a phenolic structure, to a food product. However, the chemical nature of synthetic antioxidant compounds limits the distribution of these compounds into the polar lipid fractions of a food product to effectively prevent lipid oxidation. (See, e.g., Kanner et al., Meat Sci. (1994) 36, 169-189).

In general, the antioxidation effects of a variety of natural and synthetic polyphenolic compounds have been investigated and are known in the art. However, owing to toxicological and nutritional considerations, only a very few synthetic antioxidants are currently permitted in food applications, e.g., butylhydroxytoluene (BHT), butylhydroxyanisole (BHA), propyl gallate (PG) and t-butyl hydroquinone (TBHQ). Even these antioxidants are now being examined by regulatory agencies and consumer activist groups. These recent developments have prompted the need to exploit new sources of natural antioxidants.

Thus, there have been some attempts to identify other types of antioxidants for use as preservatives in a number of applications. For example, Chen et al., describe the effect of antioxidants (sesamol, quercetin, rutin, BHT, and rosemary oleoresin) on lipid oxidation of raw and irradiated pork during a nine day period, during which it was reported that the generation of volatiles was reduced by sesamol and quercetin. However, the effects of these antioxidants on color changes of raw pork patties were minor and inconsistent. (See Chen et al., J. Food. Sci. Institute of Food Technologists, (1999) 64 (1) 16-19).

Also, Heinonen et al., describe the effect of bovine serum albumin (BSA) on the antioxidant activity of phenolic compounds, grape extracts and red wines in a lecithin-liposome system oxidized at 37° C. with copper. It was found that in the absence of BSA, the phenolic compounds inhibited hydroperoxide formation in decreasing order: ferulic acid, epicatechin, catechin, rutin, malvidin, caffeic acid, quercetin, and propyl gallate. In the presence of 20% BSA, liposome oxidation was much slower and ferulic acid followed by malvidin and rutin were the most efficient in inhibiting lipid and protein oxidation. (See Heinonen et al., J. Agric. Food. Chem., American Chemical Society, (1998) 46 (3) 917-922).

Other research in the area of natural antioxidants has included a comparison of the antioxidant activity of aspalathin, the major flavonoid of unfermented rooibos tea, with that of other polyphenols present in rooibos tea such as for example alpha-tocopherol, BHT, and BHA. It was found that compounds with the highest degree and rate of scavenging were caffeic acid and aspalathin, respectively. (See Von-Gadow et al., J. Agric. Food. Chem., American Chemical Society, (1997) 45 (3) 632-638).

Furthermore, Ramanathan et al., describe lipid oxidation in salted cooked ground fish treated with several natural products (polyphenols, dried spices and fresh spices) was measured by the production of TBARS. It was found that dried spices were more effective antioxidants than fresh spices and that the polyphenols were the most potent group of natural antioxidants. The order of potency of the polyphenols (0.01% concentration) was found to be: ellagic acid>tannic acid>myricetin>quercetin. (See Ramanathan et al., J. Food. Sci. Off. Publ. Inst. Food. Technol. (1993) 58 (2) 318-320, 360).

Ramanathan et al., studied the effects of several antioxidants on lipid oxidation in ground fish. It was found that L-Ascorbic as well as polyphenols such as quercetin (200 ppm), myricetin (200 ppm), tannic acid (30 and 200 ppm), and ellagic acid (30 and 200 ppm) were potent antioxidants in steamed and microwave cooked fish stored below 4° C. for one week. (See Ramanathan et al., J. Agric. Food. Chem. (1992) 40(1) 17-21).

Also, Wanasundara et al., describe a comparison between flavonoids in refined-bleached (RB) canola (double-zero rapeseed) oil with that of synthetic antioxidants, namely, butylated hydroxyanisole (BHA) and butylated hydroxytoluene (BHT). Among the flavonoids tested, it was found that the addition of myricetin, the most active flavonoid tested, delayed the induction period of lipid oxidation by up to fifteen days and inhibited the formation of oxidation products by 69% during this period. (See Wanasundara et al., Food. Chem. Oxford: Elsevier Science Limited, (1994) 50 (4) 393-396).

### BRIEF SUMMARY OF THE INVENTION

The present invention is summarized as compositions and methods for inhibiting lipid oxidation in food products susceptible to lipid oxidation. The methods of the present invention inhibit lipid oxidation by introducing lipopholic antioxidants which are extracted from fruit into products from a variety of industries, such as for example, animal muscle, animal feed, emulsions, pet food and cosmetics. The present invention further relates to compositions derived from fruit extracts that can be introduced into products susceptible to lipid oxidation, so as to reduce spoilage and extend shelf life by inhibiting lipid oxidation.

One aspect of the invention provides for introducing an effective amount of a fruit extract into a food product susceptible to lipid oxidation using an antioxidant carrier to carry the at least one lipophilic antioxidant into a phospholipid membrane to facilitate food preservation.

In another aspect the invention provides a method of preserving a muscle food by introducing a fruit antioxidant in the food product.

In another aspect the invention provides a composition composed of a food product susceptible to lipid oxidation and a fruit extract.

In yet another aspect the invention provides a fruit antioxidant including any one of quercetin, isoquercitrin, cinnamic acid, anthocyanin, flavonoid, or proanthocyanidin and mixture thereof to facilitate food preservation.

In another aspect the invention provides that the fruit extract may be in a crude extract or a substantially purified form.

In still another aspect the invention provides that the fruit extract may be in a powder or liquid form.

In another aspect the invention provides that the fruit from which the lipophilic antioxidant is extracted is a member of the genus vaccinium.

In another aspect the invention provides that the fruit used to extract the lipophilic antioxidant include any one of cherry, raspberry, blackberry, strawberry, or pomegranate and mixture thereof.

In another aspect the invention provides that the fruit used to extract the lipophilic antioxidant is a cranberry (Vaccinium macrocarpon Ait.).

In another aspect the invention provides that food product susceptible to lipid oxidation is animal muscle, emulsion, oil, cream, animal feed or pet food.

Unless otherwise defined, all technical and scientific terms used herein have the same meaning as commonly understood by one of ordinary skill in the art to which this invention belongs. Although suitable methods and materials for the practice or testing of the present invention are described below, other methods and materials similar or equivalent to those described herein, which are well known in the art, can also be used.

Other objects, advantages and features of the present invention will become apparent from the following specification taken in conjunction with the accompanying drawings.

### BRIEF DESCRIPTION OF THE SEVERAL VIEWS OF THE DRAWINGS

FIG. 1 illustrates the chromatographic separation of components in fraction 4.

FIG. 2 illustrates the effect of different cranberry fractions on TBARS development in Mechanically Separated Turkey (MST).

FIG. 3 Chromatographic separation of cranberry components in chloroform extract.

FIG. 4 illustrates the effect of cranberry press cake on lipid oxidation in MST.

FIG. 5 illustrates the effects of quercetin and cranberry fraction on lipid oxidation in MST.

FIG. 6 illustrates the effect of cranberry press cake on lipid oxidation in corn oil.

FIG. 7 illustrates the effect of quercetin on lipid oxidation in salmon oil-in water emulsion.

FIG. 8 illustrates the effect of cranberry fractions 1,3 and 5 and quercetin on lipid oxidation in salmon oil-in water emulsion.

FIG. 9 illustrates the effect of cranberry fractions (e.g., Fraction 4) on lipid oxidation in salmon oil-in water emulsion.

FIG. 10 illustrates the effect of all cranberry fractions and quercetin on lipid oxidation in salmon oil-in water emulsion.

FIG. 11 illustrates the effect of cranberry press cake on lipid oxidation in MST (organic phase).

FIG. 12 illustrates the effect of cranberry press cake on lipid oxidation in MST (aqueous fraction).

FIG. 13 illustrates the effect of solvent as a carrier for cranberry powder on TBARS formation in MST.

FIG. 14 illustrates the effect of different cranberry fractions on TBARS development in cooked ground pork using LH-20 fractionation.

FIG. 15 illustrates the effect of different cranberry fractions on TBARS development in MST using LH-20 fractionation.

FIG. 16 illustrates the partitioning coefficient (Pw/o) of different cranberry fractions in water-soybean oil system.

FIG. 17 illustrates the effect of chloroform extract from cranberry powder on TBARS development in MST.

FIG. 18 chromatographic separation of components in chloroform extract from cranberry powder.

FIG. 19 illustrates the particle size distribution in oil-in-water emulsions prepared by sonication.

FIG. 20 illustrates the NADPH:quinione reductase induction by cranberry fractions.

FIG. 21 illustrates the scavenging capacities of cranberry fractions toward DPPH radical.

FIG. 22 illustrates the effect of cranberry fractions on lipid oxidation in washed cod muscle.

FIG. 23 illustrates the effect of quercetin on lipid oxidation in washed cod muscle.

FIG. 24 illustrates the effect of dietary cranberry powder (15% of diet fed for approximately 6 months) on loss of redness (a* value) in bacon exposed to air during 8 days of refrigerated (4° C.) storage.

### DETAILED DESCRIPTION OF THE INVENTION

The present invention relates to compositions and methods for inhibiting lipid oxidation in food products susceptible to lipid oxidation. The methods of the present invention inhibit lipid oxidation by introducing lipopholic antioxidants which are extracted from fruit into products from a variety of industries, such as for example, animal muscle, animal feed, emulsions, pet food and cosmetics as described herein. The present invention further relates to compositions derived from fruit extracts and introduced into products susceptible to lipid oxidation, so as to reduce spoilage and extend shelf life by inhibiting lipid oxidation.

Lipid Oxidation in Food Products

In accordance with the present invention it is generally understood that polar lipids of fatty food products are typically more prone to oxidation than are the triacylglycerols (fats or oils) of whole muscle. The low oxidative stability is in large part due to incorporation of oxygen and a release of heme catalysts, degradative enzymes, and/or metallic ions which result from cellular disruption during grinding or mincing of meat products. Ultimately, this leads to the formation of unpleasant odors, colors, flavors, coloration, changes in texture, and in some cases formation of potentially toxic compounds.

The polar membrane lipids of the muscle are considered more susceptible to oxidative deterioration than the neutral triacylglycerols (muscle storage lipids). This is due to the higher degree of unsaturation in polar lipids and the larger surface area of the membranes. In addition, some membranes, in particular the mitochondrial membranes and the sarcoplasmic reticular membranes, have been shown to stimulate lipid oxidation post-mortem. The dark (oxidative) muscle contains higher amounts of membrane lipids than the light (glycolytic) muscle, more pro-oxidants such as heme compounds, and more low molecular weight metal catalysts which can catalyze oxidation of muscle lipids. It is therefore important to inhibit or retard those deleterious changes accompanying oxidation through the addition of antioxidants.

Antioxidants

Numerous natural and synthetic compounds are known to possess antioxidative characteristics, most of which are monohydric or polyhydric phenols with various ring substitutions. The three main groups of antioxidants, which are categorized according to their mode of action, include oxygen free-radical terminators, chelators of metal ions that can catalyze lipid oxidation, and oxygen scavengers that react with oxygen in closed systems. For further details, See Shahidi et al., Crit. Rev. Food Sci. Nutr. 31:67-103, (1992); and Giese, Food Technol. 50:73-80, (1996). The first class of antioxidants rapidly donate a hydrogen atom to a lipid free radical to form a relatively stable antioxidant radical. This radical is incapable of initiating or propagating the chain reaction, thereby terminating oxidation. The naturally occurring free-radical terminators include three major classes of compounds, the tocopherols, carotenoids, and ubiquinols, all of which are lipid soluble. The tocopherols and ubiquinols are polyphenolic compounds widely distributed in animal and plant tissues. The synthetic free-radical terminators currently approved for use in foods by the United States Food and Drug Administration include butylated hydroxyanisole (BHA), butylated hydroxytoluene (BHT), propyl gallate (PG) and Ibutylhydroquinone (TBHQ). However, even these antioxidants are now being examined by regulatory agencies and consumer activist groups. Thus, prompting researchers to exploit other sources for natural antioxidants.

In referring to natural sources of antioxidants, applicants have found that fruits are a rich source of natural phenolic compounds that potentially can replace undesired synthetic antioxidants. As used herein “fruit(s)” refers to berries found in the genus vaccinium, which include blueberry, bilberry, cowberry, cranberry, crowberry, farkleberry, lingonberry, partridgeberry, huckleberry, whortleberry, sparkleberry, bearberry, craneberry, lingonberry, lingberry, bilberry, burren myrtle, dyeberry, hurtleberry, whinberry, or wineberry, and mixtures thereof. Also, suitable as a rich supply of antioxidants are cherry, raspberry, blackberry, strawberry, or pomegranate and mixtures thereof. Cranberries have been found to be particularly effective as antioxidants. Cranberries may be processed by a number of means known to those skilled in the art and described below. In particular, the press cake from cranberry juice production represents is an under-utilized source of phenolics that is utilized by the present invention. The isolation of antioxidants from various cranberry sources, such as press cake is also described herein below. Cranberry antioxidants may be introduced either in a powder or liquid form into a variety of products susceptible to lipid oxidation described herein.

Products Susceptible to Lipid Oxidation

It is encompassed within the scope of the present invention that products susceptible to lipid oxidation include animal muscle, emulsions, oils, creams, cosmetics and pet foods. These products may be treated with fruit-based lipophilic antioxidants using the methods of the present invention to extend shelf life and prevent spoilage. The animal muscle mixture to which an antioxidant may be added can be any edible animal muscle, such as for example a beef steak, pork chop, or chicken thigh. However, the methods of the invention are particularly useful for macerated, chopped, or ground beef, pork, chicken, turkey, or fish, since the mechanical manipulation of such animal muscle will increase the surface area of the animal muscle that is exposed to air (i.e., oxygen). Furthermore, mechanically separated turkey (MST) is prepared by passing poultry skeletal frames and necks through an apparatus, which applies pressure to separate tissues from the bones. The bone material is discarded and the tissue is formulated into various muscle foods. MST is especially sensitive to becoming rancid. It is under such circumstances that the addition of an antioxidant to the polar lipid fraction of the MST mixture will be especially useful.

Likewise, salad dressings (e.g., mayonnaise [i.e., a mixture of oil and egg phospholipids]), various fish oils, dehydrated vegetables (e.g., potato granules), doughs (e.g., pastry crusts, breads, cakes, cookies, crackers, and the like), soy products (e.g., tofu), dairy products (e.g., milk, cheese, yogurt, and the like), peanut butter, and mashed legumes (e.g., mashed beans, mashed peas, and hummus), may be treated as described below by the methods of the invention. In accordance with the invention, antioxidants can be added to each of these food products and to their intermediates in order to enhance food preservation.

Furthermore, as used herein food product encompasses pet foods and animal feed, such as for cats, dogs, pigs, birds, horses, and fish among other animals.

Addition of Antioxidant into Products

In the U.S., the amount of antioxidant (synthetic) that can be present in commercial food products is regulated by the Food and Drug Administration (FDA). In general, a maximum of 200 parts per million (ppm) antioxidant in the fat portion of a food is allowed. An exception to this rule has been tocopherol, which can be present at a concentration of up to 300 ppm in fat. Given these regulatory considerations, it is especially appropriate to use natural fruit-based sources of antioxidants, for delivery into the specific food fraction (e.g., membrane, neutral lipid, polar lipid fraction), which is most susceptible to oxidation or spoilage.

A rich natural fruit-based source of antioxidants is cranberries which are known to effectively inhibit lipid oxidation reactions. The crude extract isolated from fruit such as cranberries includes a variety of polyphenolic compounds such as quercetin, isoquercitrin, cinnamic acid, anthocyanin, flavonoid, or proanthocyanidin and mixtures thereof. It is envisioned that natural or synthetic derivatives of these phenolic compounds may be suitable for use in inhibiting lipid oxidation in products susceptible thereto.

A particularly suitable and effective antioxidant for inhibiting lipid oxidation in a variety of food products has been found to be quercetin, in its substantially pure for, because contaminants may reduce quercitin's antioxidant properties. It is noted that historically, quercitin has been known as a bioflavonoid. Bioflavonoids are nutrients that are found in some fruits and various leafy green vegetables, among other things. Specifically, quercitin is naturally present in teas—both green and black—apples, onions, and beans. Other well known bioflavonoids include hesperidin and rutin. It is encompassed within the scope of this invention that other known bioflavonoids such as hesperidin and rutin may be suitable for use to inhibit lipid oxidation in products susceptible to oxidation.

In general, an antioxidant in any suitable solvent can be introduced into a food product. The nature of the solvent will depend on whether it is desirable to selectively deliver the antioxidant to the neutral or polar lipid fractions of a food product (e.g., a mixture containing animal muscle). It is usually desirable to selectively deliver antioxidants to the polar lipid fraction because it is the oxidation of polar lipids that is often most responsible for the unpleasant odors, colors, and tastes associated with spoilage. Furthermore, Hultin et al., recently reported that the efficiency of a particular antioxidant may be related to its particular location within the product. Since, oxidation is considered to occur at the lipid-water interface, it is therefore of particular importance that the antioxidant be placed at or near the origin of initiation and/or propagation for optimal protection against oxidation. (See, e.g., WO 01/32040).

Similarly, it has been reported that in muscle foods, the phospholipid membrane is considered the most susceptible lipid fraction to lipid oxidation and is therefore important in the development of flavour and off-flavour in meat products. (See in Composition of meat in relation to processing, nutritional and sensory quality: from farm to fork; K. Lundstrom; I. Hansson and E. Wiklund, Eds.; ECCEAMST: Utrecht, (1995) 119-128). The concept that antioxidant protection is most needed in the phospholipid membranes is explained by the fact that neutral lipids have much lower surface area and lower degree of unsaturation compared to the phospholipids. Thus, any procedure that would “drive” antioxidant into the phospholipids should be more effective at extending shelf life compared to an antioxidant that becomes diluted in the neutral lipids of non-myofibrillar lipid depots. This is because less antioxidant will be needed per gram of food product to ensure adequate shelf life.

Furthermore, technologies to increase the concentration of lipophilic antioxidants (tocopherols) into the membrane fraction have been also described (See,. e.g., Sigfusson et al., Partitioning of exogenous delta-tocopherol between the triacylglycerol and membrane lipid fractions of chicken muscle. J. Agric. Food Chem. (2002) 50, 7120-6.) The concept is that many muscle foods have neutral lipids added to lean tissue to enhance palatability, and lipophilic antioxidants will partition into membrane phospholipids better if the antioxidant is added prior to the neutral lipid. Other technologies are rapidly evolving that involve choosing an antioxidant carrier with an optimal dielectric constant (See, e.g., Raghavan et al., Selective incorporation of a lipid-soluble antioxidant into the membrane fraction of fish muscle. Trans Atlantic Fisheries Conference (2003) Reykjavik, Iceland). Therefore, research efforts within the scope of the present invention are envisioned to drive fruit-based lipophilic antioxidants into the phospholipid membranes of food products susceptible to lipid oxidation.

One novel strategy employed by the present invention has been to incorporate cranberry antioxidants (e.g., crude extract) into food products susceptible to lipid oxidation. The crude extract contained various types of compounds including cinnamic acids, anthocyanins, flavonoids, and proanthocyanidins. It is likely that for a specific food product, one class of compounds may be more effective than another. Thus, it was believed that if the crude extract were applied, the efficacy of the active class may be “diluted” by the less active classes of compounds that are present depending on the product. Therefore, applicants introduced antioxidants into the specific food products in accordance with the present invention, fractionation studies were done and the efficacy of different phenolic classes present in cranberry were assessed.

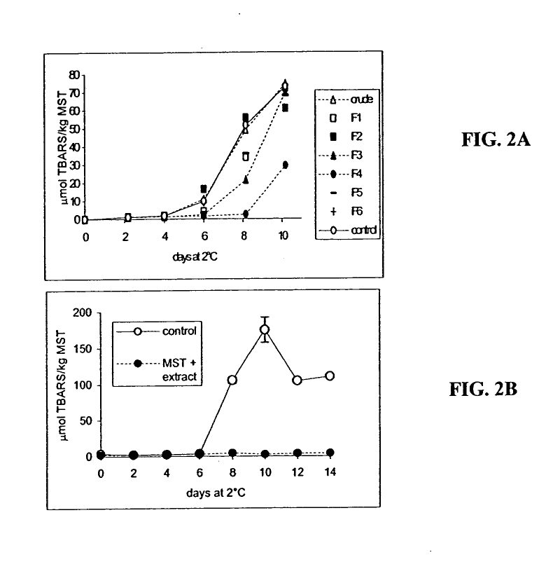

The chloroform extract (indicating high lipophilicity) from cranberry was found to be highly inhibitory to lipid oxidation in MST (See, FIG. 2). Specifically, LH-20 fractions at 0.008% of sample weight are shown in FIG. 2A; and chloroform extract fractions at 0.014% of sample weight are shown in FIG. 2B. These studies indicate that certain classes are much better inhibitors of lipid oxidation than the crude extract or other phenolic classes (See FIG. 2). Thus, a variety of approaches to concentrate lipophilic components of cranberry into membrane phospholipid fractions of various food products are described herein.

The invention will be further described in the following examples, which do not limit the scope of the invention defined by the claims.

### EXAMPLES

### Example 1

### Identification of Cranberry Components that Best Inhibit Lipid Oxidation in Mechanically Separated Turkey (MST)

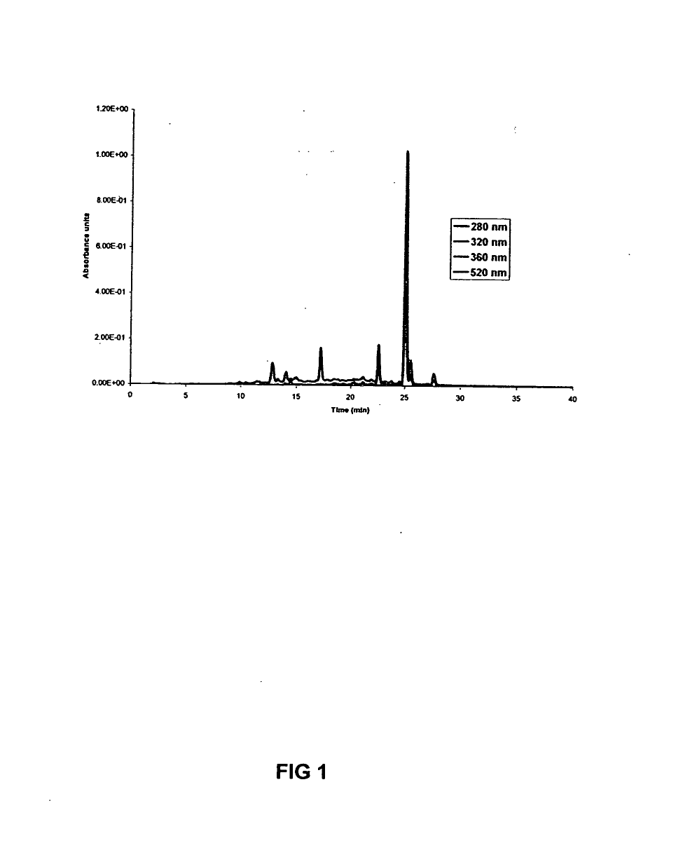

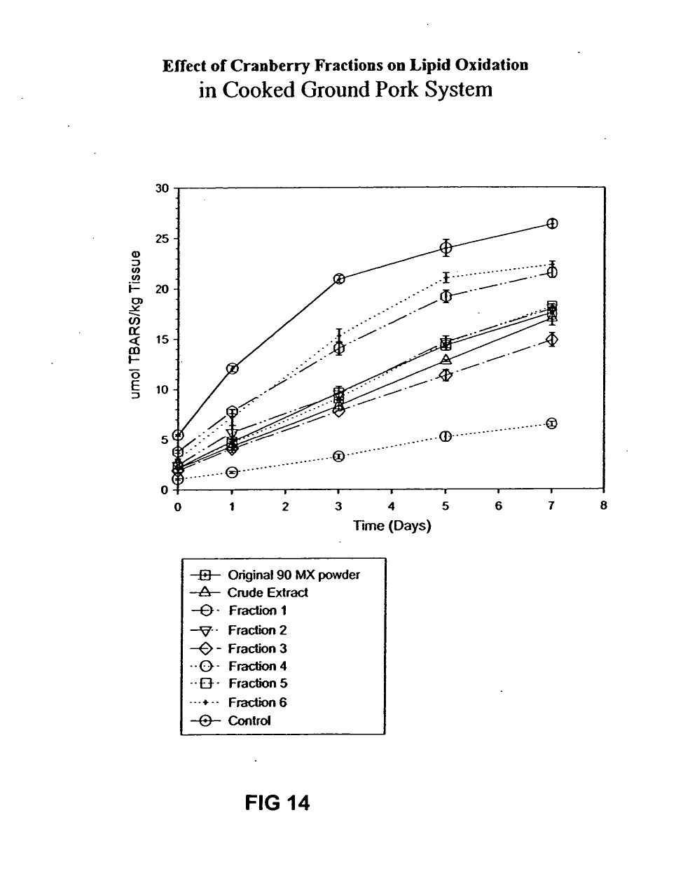

In practicing the present invention LH-20 resin and sequential water/ethanol/methanol/acetone solvents were utilized to prepare six fractions from cranberry. Further sub-fractionation of each fraction by analytical HPLC using C18 resin was performed to allow individual compounds to be resolved (water:methanol gradient). The predominant class of cranberry phenolics in each fraction was determined based on absorbance values at 280, 320, 360, and 520 nm. For example, fraction 2 was found to be rich in anthocyanins since the peaks had maximal absorbance at 520 nm. The chromatograph of fraction 4 indicated the presence of 4 flavonoids (360 nm absorbance) and 3 proanthocyanidins (280 nm) as shown in FIG. 1. Fraction 4 were found to be the most effective at inhibiting lipid oxidation in MST compared to the other fractions 1, 2, 3, 5, and 6; cranberry powder and crude extract (FIG. 2, 15). Similarly, fraction 4 from cranberry powder was also found to be the best inhibitor of lipid oxidation in cooked pork sausage (FIG. 14). As used herein, applicants note that the term “substantially purified compound” would include any fraction containing the highest percentage of quercetin (e.g., fraction 4 or 6), as compared to the other fractions from fruit extract which have been subjected to fractionation using a variety of analytical techniques.

The isolates of the individual compounds from fraction 4 were then prepared using Flash chromatography and C18 resin (water:methanol gradient). Initial trials with the low-pressure flash chromatography system indicated that substantial yields of individual compounds were collected in a more reasonable amount of time compared to the HPLC method (data not shown). The individual compound that most effectively inhibited lipid oxidation in MST was identified by mass spectrophotometery. It is believed that some synergy between two or more components found in fraction 4 may exist. Furthermore, equivalent inhibition of lipid oxidation in MST by both samples (Fraction 4 and quercitin on an equivalent weight basis) was analyzed during a storage study to support the notion that a single compound resulted in the inhibitory effect.

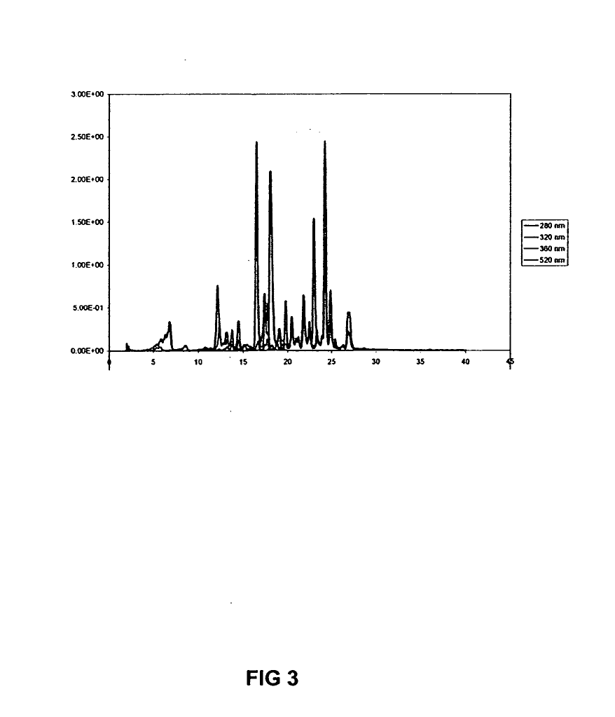

A chloroform extract from cranberry was also found to be highly effective at inhibiting lipid oxidation in MST as shown in FIG. 2. Analytical HPLC C18 chromatography of the chloroform extract indicated that around 18 compounds were present in the extract (FIG. 3). It is believed that a non-linear water:methanol gradient using the Flash system may be used to further enhance separation and isolate individual compounds. Trifluoroacetic acid may also be added to the mobile phase at 0.1% to improve resolution. These individual compounds from the chloroform extract that most effectively inhibit lipid oxidation in MST are typically identified by mass spectrophotometery.

LH-20 Fractionation of Compounds from Cranberry

In practicing the present invention one approach for isolating potent compounds was by using LH-20 fractionation to fractionate spray-dried concentrated juice powder supplied by Ocean Spray. As indicated herein above, there are many types of “antioxidants” in cranberries. These include cinnamic acids, anthocyanins, flavonoids and proanthocyanidins. It has been shown that these different classes of compounds can be fractionated with Sephadex LH-20 resin (See, e.g., Porter et al., Cranberry proanthocyanidins associate with low-density lipoprotein and inhibit in vitro Cu⁺²-induced oxidation. J. Sci. Food Agric. (2001) 81, 1306-1313. After removing sugars and organic acids, the majority of phenolic compounds were sequentially isolated with the following solvents using preparative HPLC: water (fraction 1) aqueous ethanol (fraction 2), ethanol (fraction 3), aqueous methanol (fraction 4), methanol (fraction 5), and aqueous acetone (fraction 6). Cranberry fractions were then freeze-dried and utilized on a weight basis.

As an example of using cranberry compounds isolated by LH-20 can be seen in FIG. 14. FIG. 14 illustrates the effect of different cranberry fractions on TBARS development in cooked ground pork using LH-20 fractionation. Specifically, in referring to FIG. 14, cranberry powder was first fractionated using LH-20 fractionation. The fractions were added at 0.008% of sample weight based on quercetin equivalents to cooked pork sausage. Cranberry powder was added at 0.52%. Iced storage was used for preservation of the meat.

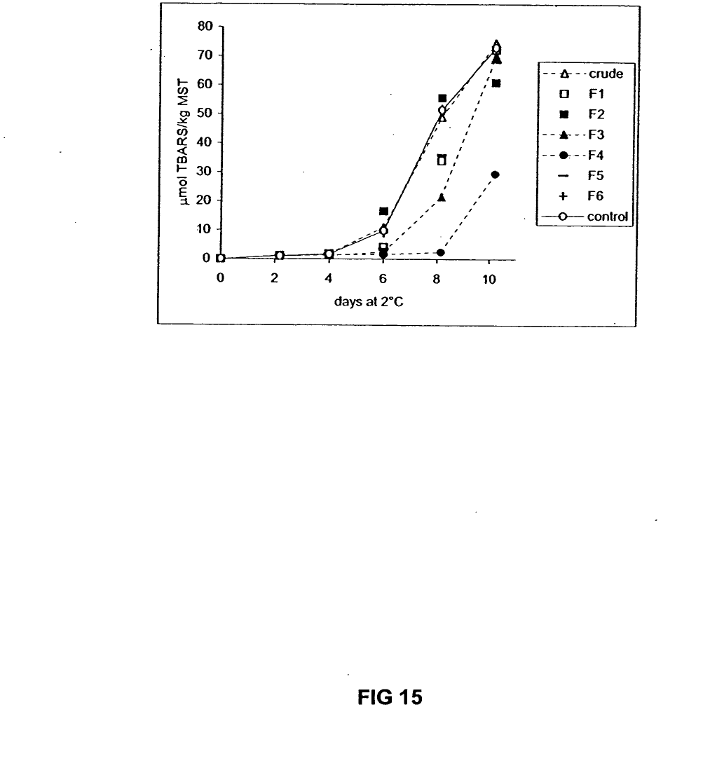

Likewise, FIG. 15 also illustrates the effect of different cranberry fractions on TBARS development in MST using LH-20 fractionation. Fractions were added at 0.008% of phenolic components based on quercetin equivalents. In both of these examples, it appears that Fraction 4 can best inhibit TBARS development.

Extraction of Lipophilic Compounds from Cranberry Sources

Lipophilic antioxidants can also be isolated from cranberry powder utilizing chloroform:methanol:water partitioning. Lipophilic compounds partition mainly into the chloroform layer. Chloroform is then evaporated under nitrogen and food grade carriers may be used to disperse the lipophilic compounds in the muscle food systems.

In one study commissioned by the applicants, MST was treated with cranberry powder (0.32%) in Oscar Mayer's processing plant in Newberry, S.C. and was compared to an untreated control along with a rosemary treated sample. Putrid odors were detected in the rosemary treatment later in storage while the cranberry treated sample was without these odors (Table 1). Furthermore, it was observed that rancidity occurred most rapidly in untreated controls. Also, lipid oxidation products based on TBARS formed most rapidly in controls while cranberry and rosemary were equally effective at inhibiting lipid oxidation (Table 1). Applicants note that currently, rosemary is used by Oscar Mayer in MST at a level of 0.05%.

TABLE 1
Effect of cranberry powder (0.32%) and rosemary extract
(0.05%) on lipid oxidation in mechanically separated
turkey based on TBARS values.

| | | Mmol TBARS/kg | |
|---|---|---|---|
| Sample | Day of ice storage | tissue | Rancidity^{a} |
| MST | 8 | 2.3 ± 0.1 | 0.50 ± 0.22 |
| | 12 | 40.9 ± 9.7 | 3.48 ± 0.62 |
| | 14 | 58.8 ± 2.1 | 5.90 ± 0.51 |
| MST + cranberry | 8 | 1.6 ± 0.3 | 0.48 ± 0.22 |
| | 12 | 1.2 ± 0.4 | 0.88 ± 0.35 |
| | 14 | 5.1 ± 1.4 | 1.23 ± 0.10 |
| MST + rosemary | 8 | 1.0 ± 0.1 | 0.53 ± 0.21 |
| | 12 | 1.7 ± 0.1 | sour, putrid |
| | 14 | 3.6 ± 2.5 | sour, putrid |

^{a}Rancidity scale 0-10; 10 being highest. A score of 1.5 is slightly rancid.

Extraction of Lipophilic Compounds from Cranberry Press Cake

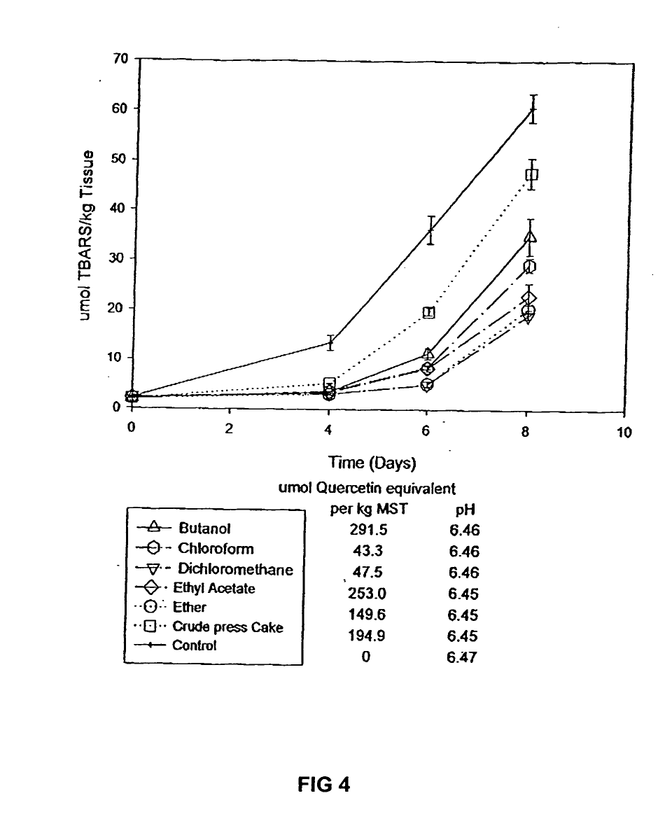

Extractions from cranberry press cake were performed using methods described herein and the freeze-dried extracts from the press cakes were tested in MST. In this example, cranberry press cake was initially extracted by acetone:H₂O (7:3) and the resulting extract (1:10) was named crude press cake. Crude press cake was further extracted with various organic solvents (1:3-dry) (e.g., butanol, chloroform, dichloromethane, ethyl acetate, or ether). The organic phase from the various extractions was evaporated and the dried material (8 mg extract) was mixed with 150 ul ethanol:propylene glycol (2:1) at a level of 0.04% (w/w). The mixture was then added into 20 MST. The ethanol (200 proof) was obtained from Aaper Alcohol and Chemical Co. (USP grade, absolute, 02G02QA). The results are shown in FIG. 4.

Essentially, the results indicated that about 400 ppm of phenolic extract was sufficient to extend shelf life of MST. Thus, by extracting press cake (1:10 solvent) with 70% acetone, a fraction was produced which resulted in only modest inhibition of lipid oxidation in MST. Alternatively, it was found that if the 70% acetone fraction was further extracted with either ethyl acetate, ether, or dichloromethane (1:3 solvent), that this secondary (more purified) extract was more effective in inhibiting lipid oxidation. However, when the same 70% acetone fraction was extracted with butanol or chloroform (1:3 solvent), only an intermediate efficacy was found with respect to inhibition of lipid oxidation in MST. It is noted that the results in FIG. 4 are presented as average±standard deviation from triplicate measurements (Lemon method—macro assay was used for these measurements.)

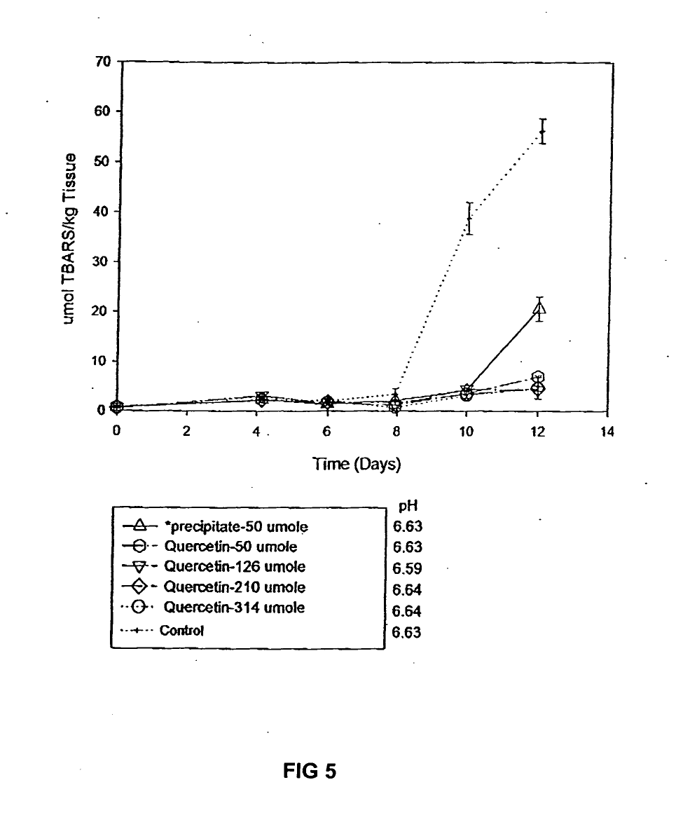

In another study conducted by the applicants, the effects of quercetin and cranberry fraction on lipid oxidation in MST were analyzed. In this study quercetin was found to be highly effective at inhibiting lipid oxidation at only 50 umol/kg (FIG. 5). Also, one of the more highly purified extracts (referred to as a precipitate in FIG. 5) was also highly effective; however, slightly less than by the addition of pure quercetin to MST. The precipitate was obtained through the centrifugation of a 50% ethanolic suspension of the F4 fraction (LH-20) and F5 fraction (C18) described above. Then, precipitate was mixed with ethanol (293.3 ul), which was then added into 15 g MST. The ethanol (200 proof) was obtained from Aaper Alcohol and Chemical Co. (USP grade, absolute, 02G02QA). It is suspected that the precipitate extract may be contaminated with some other cranberry components that are pro-oxidative. Alternatively, the small amount of other polyphenolics in the extract may be diluting the quercetin effect since the extract is added on a quercetin equivalent basis. It is noted that the results in FIG. 5 are presented as average±standard deviation from triplicate measurements (Lemon method—macro assay was used for these measurements).

Detection of Antioxidant Molecules

The detection of particular antioxidant molecules are well within the scope of ordinary skill in the art of food chemistry. For example, the separation and detection of the tocopherols have been described in Lang et al., “Vitamin E,” In: Modern chromatographic analysis of vitamins, pp 153-195. High performance liquid chromatography (HPLC) methods are generally suitable and have several advantages. These methods offer higher precision than other methods, are less labor intensive, can be automated, require less sample cleanup and lower temperatures, and have shorter separation times on the column. Normal-phase HPLC columns (silica stationary phase) employing an organic mobile phase provide more selectivity and are generally superior for the separation of various antioxidants in spite of requiring longer equilibrium times and performing with less consistency than reversed-phase HPLC columns.

Measurement of Lipid Oxidation Products

Lipid oxidation products in MST were typically measured every other day during 16 days of iced storage. The total lipids are then extracted using chloroform and methanol (1:1). As used herein, the term “lipid peroxides” refer to indicators of primary lipid oxidation products. Lipid peroxides react with Fe(II)Cl reagent to form Fe(III). The Fe(III) then binds the reagent ammonium thiocyanate and forms a chromophore at 500 nm (See Shantha et al., Rapid, sensitive, iron-based spectrophotometric methods for determination of peroxide values of food lipids. J. AOAC Int. (994) 77, 421-424). A standard curve is constructed using cumene hydroperoxide. Since fatty acids are resistant to oxidation in organic solvents, there is no need to add antioxidants to the extracting solvent system.

Also, as used herein, the term “thiobarbituric acid reactive substances” (TBARS) refers to indicators of secondary lipid oxidation products. Lipid hydroperoxides breakdown to form various aldehydes that react with TBA reagent resulting in a chromophore at 532 nm. TBARS are determined by homogenizing tissue with trichloroacetic acid containing EDTA and propyl gallate to prevent lipid oxidation products from forming during the extraction procedure (See Lemon et al., An improved TBA test for rancidity. New Series Circular No. 51: Halifax, Nova Scotia, (1975)).

Sensory Analysis

In conducting the sensory analysis, panelists were trained to detect degree of rancid odor by sniffing slightly and moderately rancid references that contain a small amount of rancid menhaden oil diluted in a nearly odorless vegetable oil (See Richards et al., Effect of washing with or without antioxidants on quality retention of mackerel fillets during refrigerated and frozen storage. J. Agric. Food Chem. (1998) 46, 4363-4371). A score of 0 to 10 was assigned to each muscle sample with 10 being highly rancid.

Identification of Inhibitory Compounds in Cranberry

Technical staff at the mass spectrophotometry facility in the Chemistry department at UW-Madison conducted analyses to identify inhibitory compounds from isolates prepared in applicants' laboratory. The LCMS electrospray ionization quadrupole analyzer was employed for this analysis.

Analysis of Data

To suitably analyze the data obtained through the above-described experiments, triplicate sampling was used to generate means and standard deviations. Experiments may be replicated two or three times. Analysis of variance (ANOVA) using the SAS system were used for comparing means in the event of a successful F-test. Means were separated using the Duncans Multiple Range test (See, e.g., Cody et al., Applied statistics and SAS programming language, 4th ed.; Prentice Hall: Upper Saddle River, N.J., (1997); 150-188.).

### Example 2

### Partitioning Measurements of Cranberry Antioxidants in Muscle Foods

A indicated hereinabove, it has been shown that lipophilic antioxidants (tocopherols) could be driven into the phospholipid membrane fraction of muscle foods and therefore oriented away from neutral lipids. This is desirable since phospholipids are believed to be the most susceptible lipid fraction to lipid oxidation processes (See, Gandemer et al., (1995) 119-128). Conveniently, the most powerful antioxidants in cranberry are highly lipophilic. This is based on applicants' observation that a chloroform extract from cranberry contains lipophilic compounds and was highly effective at inhibiting lipid oxidation in MST (FIG. 2). This strongly suggests that cranberry antioxidants can be driven into the membrane fraction where they are most needed. To confirm this, the partitioning of cranberry components in the different phases of muscle food systems may be measured (e.g., membrane phospholipids and neutral lipids).

One approach for measuring cranberry components may be to mix Nagarase (0.005%) into the muscle food system and incubate for 60 min at 4° C. (See Sigfusson et al., J. Agric. Food Chem.(2002) 50, 7120-6). Nagarase breaks down structural proteins to release membrane material. After incubation, the cranberry antioxidants that are identified herein will be minced with muscle for 20 seconds in a food processor. This is followed by isolation of membrane lipids and neutral lipids. Each lipid class is then separately dissolved in chloroform and the amount of cranberry antioxidant in each phase determined by HPLC separation and analysis. Sodium ascorbate can then be added to protect cranberry antioxidants from oxidation during partitioning and analysis. A level of 0.2% ascorbate in the minced muscle and buffers employed for membrane isolation may be used for such protection.

Isolation of Membrane Fraction

A modification of the method of McDonald and Hultin for the isolation of flounder microsomes may be used to isolate the membranes from the different muscle tissues (See McDonald, et al., Membrane lipid oxidation in a microsomal fraction of red hake muscle. J. Food Biochem. (1980) 3, 125-134). Alternatively, MST and chicken leg muscle contain large amounts of mitochondria. It requires a high degree of homogenization to liberate mitochondria. Disintegration of mitochondrial membrane is also a concern in these highly pigmented muscles so tissues are generally kept cold and utilized within 24 hours post mortem when possible. Homogenization is done in HEPES (pH 7.5). Muscle is then centrifuged at 10000×g. The resultant supernatant is then centrifuged at 130000×g and the final sediment is suspended in HEPES. A high ionic strength buffer (0.6 M KCl) is also incorporated to aid in removal of actomyosin from the membrane preparation (See Sigfusson et al., J. Agric. Food Chem. (2002) 50, 7120-6). Phospholipid content is determined based on phosphorous analysis as described previously (See, e.g., Anderson et al., An organic phosphorus assay which avoids the use of hazardous perchloric acid. Clin. Chim. Acta (1982) 121, 111-116).

Isolation of Triacylglycerol Fraction (Neutral Lipids)

Triacylglycerols from ground muscle were isolated by centrifuging the muscle at 130000×g for 30 min at 35-40° C. The supernatant contained the recovered triacylglycerols.

Concentrations of Inhibitory Compounds in the Different Lipid Fractions

To quantify the inhibitory compounds, phospholipid membrane and neutral lipid fractions were separately dissolved in chloroform prior to HPLC analysis. The mobile phase was pumped isocratically (98.5% hexane/1.5% 2-propanol) (See Petillo et al., Kinetics of antioxidant loss in mackerel light and dark muscle. J. Agric. Food Chem. (1998) 46, 4128-4137.) A C18 column was used to resolve the components in the lipid extract. The HPLC system was equipped with fluorescence and photo diode array detectors and full spectrum software, which allowed for quantification of individual cranberry compounds using known standards. The cranberry compounds examined were those that were identified hereinabove (i.e., quercetin, isoquercitrin, cinnamic acid, anthocyanin, flavonoid, or proanthocyanidin).

### Example 3

### Antioxidant Activities of Cranberry Components in Muscle Foods

In accordance with the invention, cranberry juice powder was extracted and fractionated with water, aqueous ethanol, methanol, and acetone. Cranberry press cake isolate was obtained by various solvent extractions (e.g., butanol, chloroform, dichloromethane, ethyl acetate, or ether). The level of thiobarbituric acid reactive substances (TBARS), indicators of lipid oxidation products, was determined by evaluating the inhibitory effects on the lipid oxidation in a mechanically separated turkey (MST) system. The antioxidant active cranberry components were partially characterized by reversed-phased High Performance Liquid Chromatography (HPLC) with UV-VIS diode array detection.

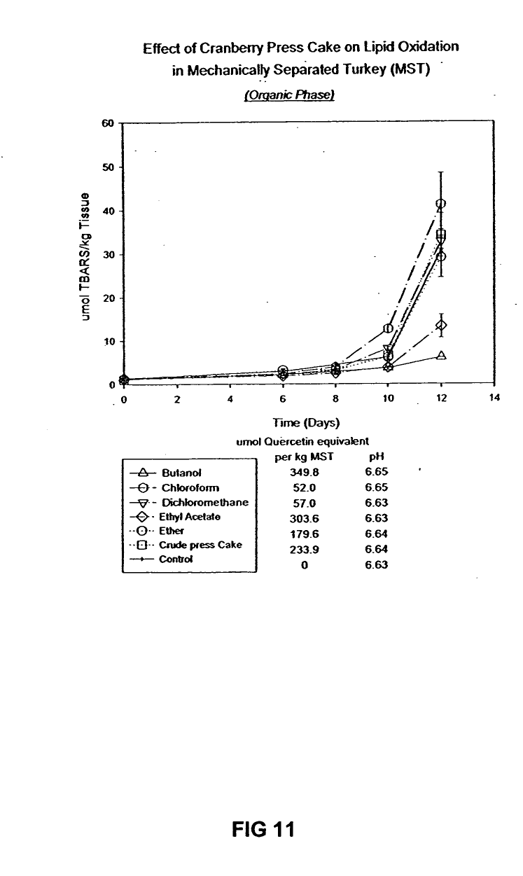

For example, in one study by the applicants, the effect of cranberry press cake on lipid oxidation in MST was analyzed. Press cake was initially extracted by acetone:H₂O (7:3) and the resulting extract was referred to crude press cake. Crude press cake was further extracted with various organic solvents (e.g., butanol, chloroform, dichloromethane, ethyl acetate, ether). Another organic solvent used was 200 proof ethyl alcohol (Aaper alcohol and chemical co.; USP grade, absolute, 02G02QA). Then, 225 ul ethanol:propylene glycol (2:1) was mixed with 12 mg extract, at a level of 0.048% (w/w), was added into 2 g MST. The results which are presented in FIG. 11 are presented as average±standard deviation from triplicate measurements (Lemon method—macro assay was used for these measurements). Applicants found that butanol and ethyl acetate were the best extracting solvents compared to various other solvents at inhibiting lipid oxidation in MST (FIG. 11). It is also noted that the residual solvent is removed prior to adding the antioxidants to the MST.

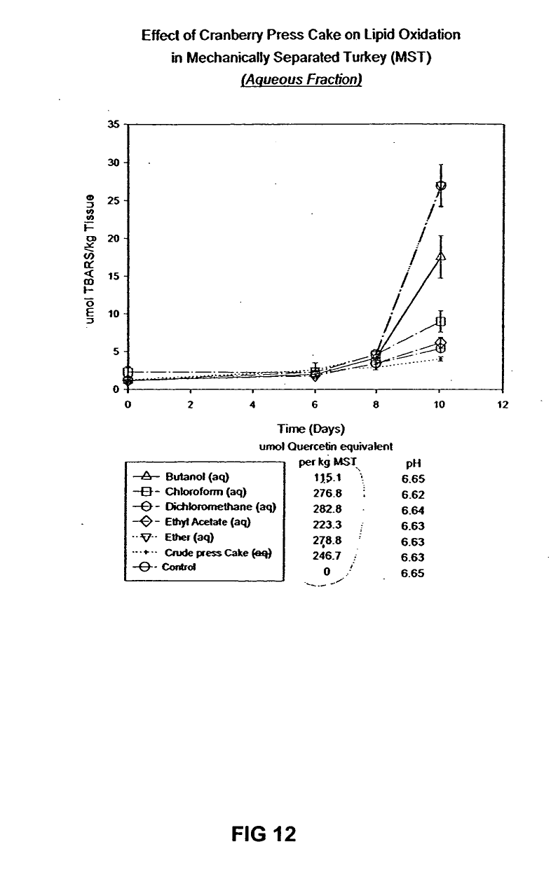

Furthermore, in the process of preparing the solvent extracts, an aqueous phase was also formed and examined. In this case, ethyl acetate and dichloromethane were the superior solvents in inhibiting lipid oxidation in MST (FIG. 12). More specifically, FIG. 12, illustrates the effect of cranberry press cake on lipid oxidation in MST (aqueous fraction). Press cake was initially extracted by acetone:H₂O (7:3) and the resulting extract was referred to crude press cake. Crude press cake was further extracted with various organic solvents (e.g., butanol, chloroform, dichloromethane, ethyl acetate, ether). Another organic solvent used was 200 proof ethyl alcohol (Aaper alcohol and chemical co.; USP grade, absolute, 02G02QA). As noted above, 225 ul H₂O:propylene glycol (2:1) with 12 mg extract, at a level of 0.048% 9 w/w), was added into 25 g MST. Results are presented as average±standard deviation from triplicate measurements. (Lemon method—macro assay was used for these measurements). The results show that the aqueous fractions also contained inhibitory components when the extracting solvent was ethyl acetate or chloroform (FIG. 12).

Similarly, applicants have found that cranberry press cake isolates are also able to delay the onset of lipid oxidation. At a level of 0.04% (w/w), the inhibitory effects of dichloromethane, ether and ethyl acetate isolates were higher than that of chloroform and butanol isolates. Again, quercetin was found to be one of the most active antioxidant components in cranberry fractions tested. Effective inhibition on lipid oxidation of MST at 2° C. storage was achieved by adding a level of 210 umol quercetin/kg MST. These results suggest that cranberry components may be used as potential natural antioxidants to enhance the oxidative stability and shelf life of muscle foods.

### Example 4

### Strategies used to Drive Cranberry Antioxidants into the Membrane Fraction of Muscle Foods

It is common practice in the industry to add adipose tissue to lean muscle tissue for improved flavor and palatability of products. Other researchers have found that lipophilic antioxidants (tocopherols) are incorporated into membrane lipids more efficiently if the antioxidant is mixed with lean tissue prior to addition of the neutral lipids (See Sigfusson et al., J. Agric. Food Chem. (2002) 50, 7120-6). Since the most powerful antioxidants in cranberry are highly lipophilic (FIGS. 2 and 3), cranberry antioxidants were added to lean tissues prior to addition of adipose fat with the goal being to drive cranberry antioxidants into the membrane fraction where they are most needed.

MST was obtained from Oscar Mayer-Kraft (Madison, Wisc.). MST with and without skin/adipose tissue was procured. Since skin is a rich source of neutral lipids, it was added to MST to raise and standardize the lipid content in MST that was destined for production of wieners and bologna. The added lipid generally provides desirable palatability and flavor to the finished products. It was also found that lipophilic cranberry antioxidants are more efficiently incorporated into membrane lipids if the cranberry phenolics are added prior to skin addition. This was accomplished by measuring the partitioning of cranberry antioxidants in different muscle phases described hereinabove. Further, it was determined that this step delays lipid oxidation during storage compared to adding antioxidant after adipose tissue has been added. Applicants note that MacFarlane Pheasants Inc. (Janesville, Wis.) was also a source of mechanically separated tissue. MacFarlane's passes pheasant drumsticks through their mini-mechanical separator, presenting a more manageable environment in which to i) add antioxidant, ii) add adipose tissue and iii) work with smaller sample sizes.

It is also common practice in the industry to add adipose tissue for improved flavor to products that do not contain mechanically separated tissue. Thus, another system in which the present invention may be applied to is minced chicken leg muscle containing added depot fat. This system mimics products such as sausages and breaded patties. The same basic principal applies that dictates better shelf life if the cranberry antioxidant is added before the neutral lipids due to better incorporation of the cranberry antioxidant into the membrane lipids. Chicken depot fat is the source of neutral lipids. Depot fat is heated at 45° C. for 30 min followed by centrifugation. The clear supernatant is then added to the ground muscle to increase the lipid content.

Applicants also envision using compositions of the present invention to drive lipophilic antioxidants from cranberry into the membrane fraction using different antioxidant carriers. It has recently been shown that the dielectric constant of the antioxidant carrier is critical in controlling the partitioning of lipophilic antioxidants into membrane lipids of muscle food systems (See Raghavan et al., Selective incorporation of a lipid-soluble antioxidant into the membrane fraction of fish muscle. Trans Atlantic Fisheries Conference (2003) Reykjavik, Iceland). Thus, different combinations of various food grade carriers with varying dielectric constants may be applicable for use with cranberry antioxidant partitioning and efficacy in muscle food systems. It is envisioned that the amount of carrier would generally maintain between 0.5 and 1.0 % as is common practice in the industry.

The effects of carrier selection and order of antioxidant addition were initially examined in prime quality, minced cod muscle (obtained via overnight delivery from Gloucester, Mass.). Cod muscle represents an excellent system to compare different strategies to drive cranberry antioxidants into the phospholipid membranes of muscle foods. One reason is because mitochondrial content is low in cod muscle. Mitochondria can disintegrate rapidly post mortem which creates lowers membrane yields. It is ideal to extract as much membrane lipid as possible when measuring how much antioxidant partitions into the membrane fraction as compared to the aqueous, protein and neutral lipid fractions. Neutral lipid content is also low in cod muscle. Thus, the effects of added neutral lipids will be minimally confounded by endogenous neutral lipids. Applicants have identified several strategies to incorporate lipophilic cranberry components into cod membranes. It is envisioned that these strategies can be tested in more complex muscle foods that are especially prone to lipid oxidation such as MST and dark muscle tissues.

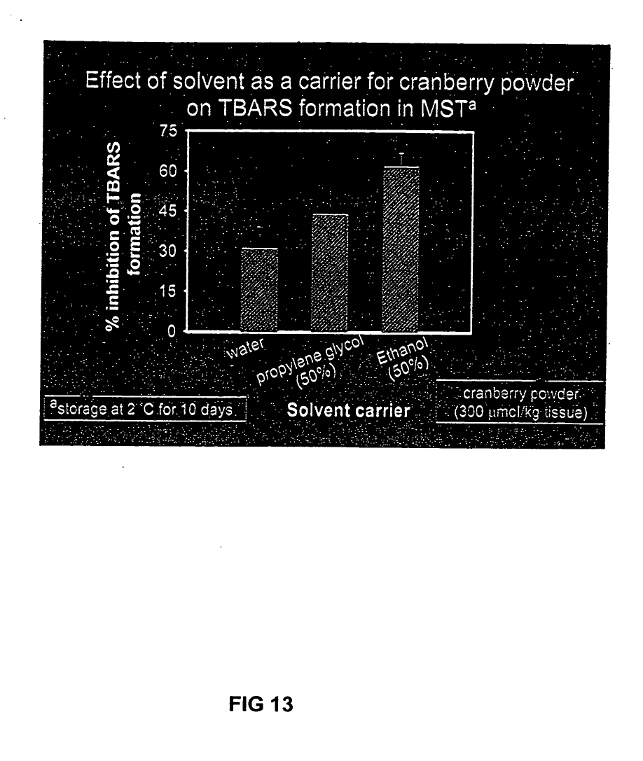

Specifically, the applicants examined three carrier systems of cranberry components in MST and found that choosing the proper carrier further extended the antioxidant efficacy of cranberry antioxidants. Ethanol was found to be more effective than propylene glycol which in turn was more effective than water carrier (FIG. 13).

Accordingly, the present invention provides a minimal-cost strategy to protect quality of muscle foods using cranberry components. This is achieved by identifying the most inhibitory components in the cranberry raw material and driving those compounds into the membrane lipids of muscle foods. Also to obtain maximal protection of food quality by cranberry antioxidants, manipulating the dielectric constant of the antioxidant carrier is a necessary factor, along with mixing in the antioxidants prior to addition of neutral lipids, so as to concentrate the cranberry antioxidants in the membrane lipids.

### Example 5

### Antioxidant Activities of Cranberry Components in Washed Cod Muscle

In order to evaluate and optimize antioxidant activities of various cranberry phenolic components in muscle foods, applicants studied their affects toward hemoglobin-mediated lipid oxidation in washed cod muscle (WCM). Accordingly, to identify the most potent cranberry components for most effectively practicing the invention, the following materials were used: spray dried cranberry concentrate juice powder 90-MX was provided by Ocean Spray Cranberries, Inc. (Lakeville-Middleboro, Mass.). Ethanol (absolute, 200 proof) was obtained from Aaper Alcohol and Chemical Co (Shelbyville, Ky.). Sephadex LH-20 was obtained from Amersham Biosciences (Uppsala, Sweden). All other chemicals and HPLC grade solvents used were obtained from Fisher Scientific (Chicago, Ill.) or Sigma-Aldrich Chemical Co. (St. Louis, Mo.).

To identify the most potent cranberry components for practicing the invention, the crude cranberry extract was prepared and fractionated according to the method described by Porter et al., Cranberry proanthocyanidins associate with low-density lipoprotein and inhibit in vitro Cu²⁻induced oxidation. J. Sci. Food Agric. 2001, 81, 1306-1313.) with minor modifications. Cranberry concentrate juice powder (4.5 g) was dissolved in 8 mL water and loaded on a Sephadex LH-20 (35 g) column (ID=2.5cm, Length=27 cm). Water (250 ml) at 1.5 mL/min was used to elute non-phenolic cranberry constituents. Subsequently, 2.5 L 80% aqueous acetone (v/v) was used to elute cranberry phenolics. A red-purple powder, which is referred to as cranberry crude extract, was obtained after removal of acetone by rotary evaporation under reduced pressure at 35° C. and removal of water by lyophilization. The cranberry crude extract (50 mg) was then dissolved in 7.5% aqueous ethanol (v/v) and subjected to a Sephadex LH-20 (23 g) column (ID=2.2cm, Length=25 cm) equipped with Agilent 1100 series binary pump and photodiode array detector (Agilent, Wilmington, Del.) for further fractionation. Seven fractions were obtained by the use of the following solvents at a flow rate of 2.5 mL min-1 (1A and 1, 100% water; 2, 50% aqueous ethanol (v/v); 3, 100% ethanol; 4, ethanol:methanol (1:1,v/v); 5, 100% methanol; 6, 80% aqueous acetone (v/v)). Fraction 1A was not used in this study due to its inadequate amount. The elution profile of fractionation of cranberry crude extract was monitored at 280, 320, 360 and 520 nm. Each fraction was concentrated under vacuum by rotary evaporation at 35° C. and lyophilization. Subsequently, all fractions were stored in 50% aqueous ethanol (v/v) at −80° C. until use.

The cranberry fractions were then characterized by reverse phase high-performance liquid chromatography (HPLC) (Krueger et al., Matrix-assisted laser desorption/ionization time-of-flight mass spectrometry of polygalloyl polyflavan-3-ols in grape seed extract. J. Agric. Food Chem. 2000, 48, 1663-1667). Cinnamic acids, anthocyanins, flavonols, flavonols, proanthocyanidins, and proanthocyanidins were enriched in fraction 1, 2, 3, 4, 5, and 6, respectively. Total phenolic content in cranberry crude extract and its fractions were quantified by a modified spectrophotometric method described by Singleton and Rossi (Singleton et al., Colorimetry of total phenolics with phosphomolybdic-phosphotungstic acid reagents. Am. J. Enol. Vitic. 1965, 16, 144-158.) with quercetin as a reference standard. Subsequently, 2.5 mL of 10× diluted (with water) Folin-Ciocalteu reagent was added to 25 mL of cranberry fraction. After 5 min, 2 mL 7.5% sodium carbonate was added into the resulting mixture. The absorbance was determined at 760 nm by a double-beam spectrophotometer model UV-2401 (Shimadzu Scientific Instruments Inc., Columbia, Md.), after the incubation of mixture at 22 to 24° C. for 2 hours. Relative yields and total phenolic content (quercetin equivalent) of cranberry fractions are shown below in Table 2.

TABLE 2
Relative yields and quercetin equivalent of cranberry fractions

| | | μmol quercetin equivalent |
|---|---|---|
| Fraction | Relative yields %^{a} | per mg (dry weight) fraction |
| 1A | 4.5 | 0.22 ± 0.01 |
| 1 | 11.6 | 0.89 ± 0.01 |
| 2 | 16.8 | 1.64 ± 0.02 |
| 3 | 16.7 | 1.88 ± 0.02 |
| 4 | 5.1 | 1.81 ± 0.02 |
| 5 | 34.3 | 1.83 ± 0.02 |
| 6 | 11.0 | 1.20 ± 0.03 |
| Total % recovery^{b} | 68.7 | |

^{a}Relative yields are expressed as % individual fraction (dry weight)
^{b}Total % recovery of 50 mg of crude cranberry extract loaded on the second Sephadex LH-20 column

In accordance with the invention, scavenging activities of cranberry crude extract/fractions toward 1,1 -diphenyl-2-picrylhydrazyl (DPPH) radical were evaluated by spectrophotometry (Cuendet et al., Iridoid glucosides with free radical scavenging properties from Fagraea blumei. Helv. Chim Acta, 1997, 80, 1144-1152). Cranberry crude extract/fractions (0.35 mL) was added to the 0.85 mL 43 mM DPPH in methanol. After a 30 min incubation at 22 to 24° C., the resultant absorbance was recorded at 515 nm by a double-beam spectrophotometer model UV-2401 (Shimadzu Scientific Instruments Inc., Columbia, Md.). Ascorbate, propyl gallate, and quercetin were used as reference standard. The scavenging capacity%=[1−((Abs of cranberry crude extract/fractions−Abs of blank)/Abs control)]*100. Control was defined as methanolic DPPH and 50% aqueous ethanol (v/v) and blank was defined as methanol and cranberry crude extract/fractions. SC₅₀ is defined as the concentration required to obtain 50% of a maximum scavenging capacity from the regression lines with 95% confidence level at the plot of % scavenging capacity vs. concentration (Choi etal., Antioxidant activity and free radical scavenging capacity between Korean medicinal plants and flavonoids by assay-guided comparison. Plant Sci. 2002, 163, 1161-1168).

Furthermore, cod muscle and trout hemoglobin were prepared according to the method described by Richards et al., Role of deoxyhemoglobin in lipid oxidation of washed cod muscle mediated by trout, poultry and beef hemoglobins. Meat Sci. 2002, 62, 157-163. The hemoglobin-mediated lipid oxidation system consisted of washed cod muscle, cranberry crude extract/fractions, streptomycin sulfate, and trout hemoglobin. The final concentration of hemoglobin and cranberry extract/fractions was 12 and 37/74 μmol per kg washed cod muscle, respectively. A control sample containing no cranberry crude extract/fractions was also prepared. The final moisture content of washed cod muscle was adjusted to 90%. pH was adjusted to between 6.10 and 6.30 by 1 M NaOH or HCl. All samples were stored at 2° C. for 7 to 9 days.

The progress of lipid oxidation in washed cod muscle was followed by periodically removing samples and quantifying TBARS formed by a modified method of Buege and Aust Microsomal lipid peroxidation. Method. Enzymol. 1978, LII, 302-310 as described by Richards et al., Role of deoxyhemoglobin in lipid oxidation of washed cod muscle mediated by trout, poultry and beef hemoglobins. Meat Sci. 2002, 62, 157-163. Lag time (LT) is defined as extension in stability compared to control sample which was stable for around 1 day. All trials in this study were conducted in duplicate or triplicate and in each trial triplicate determinations were performed

Scavenging Effect Toward DPPH Radical.

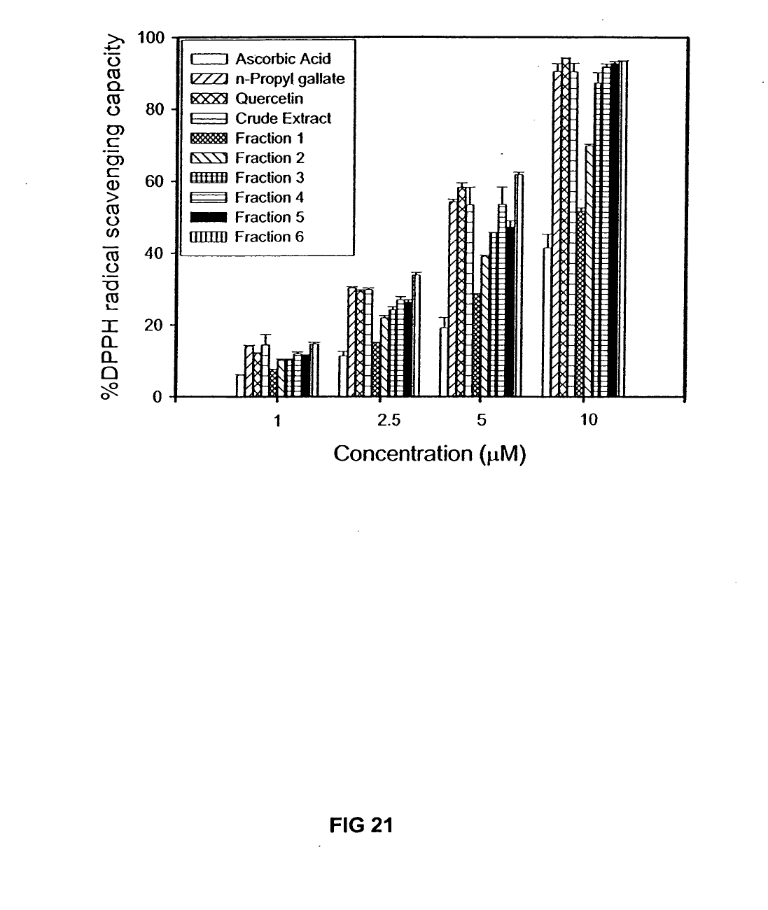

The cranberry crude extract/fractions were evaluated and compared with ascorbic acid, propyl gallate and quercetin for the free radical scavenging activity toward stable DPPH radicals. Cranberry crude extract/fractions exhibited DPPH radical scavenging activity (FIG. 21). Specifically, in referring to FIG. 21, the final concentration of DPPH radical was 43 mM. Also, the results are presented as average±standard deviation from triplicate trials and in each trial duplicate determinations were done.

A concentration-dependent response was observed with all cranberry fractions. At a level of 10 mM quercetin equivalent 51.8 -93.5% DPPH radical was quenched, whereas only 15-33.9% DPPH was quenched at a level of 2.5 mM quercetin equivalent. Among the fractions evaluated, fraction 6 showed the greatest scavenging activity (SC₅₀=4.70), follow by fraction 4 (SC₅₀=5.13), 5 (SC₅₀=5.27), 3 (SC₅₀=5.60), 2 (SC₅₀=6.87) and 1 (SC₅₀9.47). Compared to reference standards, scavenging activity of fraction 6 was stronger than that of ascorbic acid (SC₅₀=12.23), propyl gallate (SC₅₀=5.07) and quercetin (SC₅₀=4.89). Different degree of DPPH radical scavenging activity has also been reported among the different classes and within each class of phenolic compounds such as cinnamic acids, flavonols, and anthocyanins (Fukumoto et al., Assessing antioxidant and prooxidant activities of phenolic compounds. J. Agric. Food Chem. 2000, 48, 3597-3604).

The interaction between antioxidant and DPPH radical greatly depends on the structural arrangement such as the number and the location of hydroxyl group and glycosylation of these groups (Fukumoto et al., J. Agric. Food Chem. 2000, 48, 3597-3604). Increasing the number of hydroxyl groups increased the antioxidant activities of benzoic and cinnamic acid derivatives, anthocyanidins and flavonols. Also, glycosylation reduced the antioxidant activities of quercetin, cyanidin, pelargonidin and peonidin.

Antioxidant Activity Toward Hemoglobin-Mediated Lipid Oxidation in Cod.

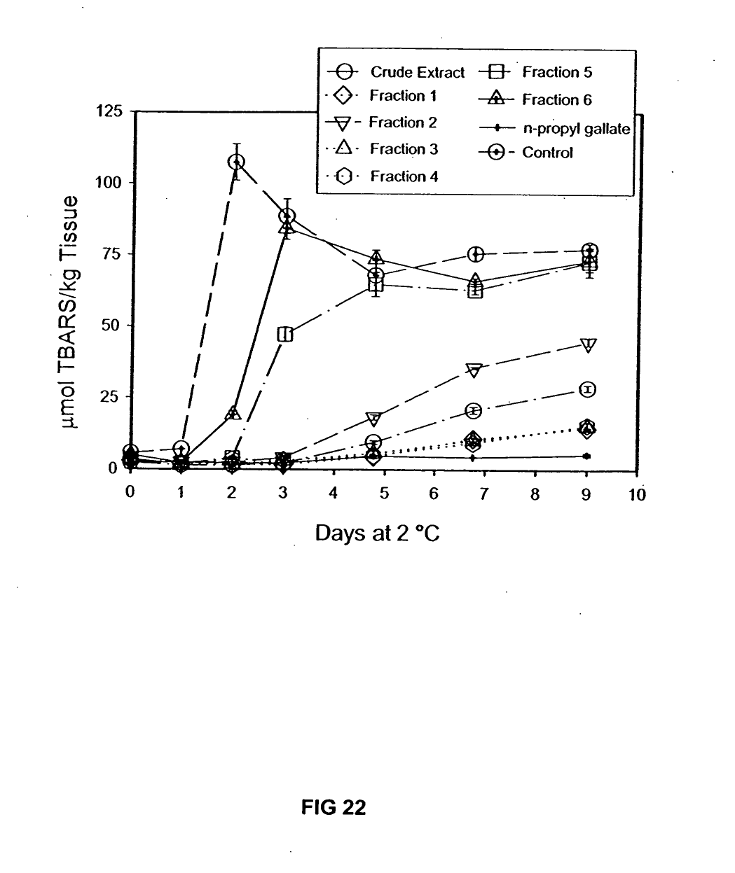

TBARS value was used as an index of lipid oxidation. Crude extract and its fractions delayed the onset of lipid oxidation and inhibited the formation of TBARS in washed cod muscle (Table 3 shown below, FIG. 22). Specifically, in referring to FIG. 22, trout hemoglobin and cranberry fractions/antioxidants were added into the system at the final concentration of 12 and 74 mmol per kg washed cod. The final pH was between 6.20 and 6.30. Also, the results are presented as average±standard deviation from triplicate determinations.

Cranberry fractions inhibited the formation of TBARS by 3.3 to 71.8% at the concentrations tested (37 and 74 mmole quercetin equivalent) (Table 3). All of the fractions were generally more effective at the higher concentration, with the exception of fraction 5 which was equally effective at both concentrations. At the concentration of 74 mmole quercetin equivalent, fraction 1 (LT=5), 3 (LT=5), and 4 (LT=5) were more effective antioxidants which exhibited more than 50% inhibition in TBARS formation and the increase in the lag time of oxidation, compared to fraction 2 (LT=2.2), 5 (LT=1.1), and 6 (LT=0.3) (Table 3, FIG. 22). Crude extract (LT=3.2) also extended the stability of washed cod muscle. The TBARS values of washed cod muscle with fraction 1, 2, 3 and 4 were 42-99% lower than that of the control over the entire storage period. The difference in the relative inhibitory activity of fractions between Table 3 and FIG. 22 is partially due to the pH difference (pH 6.2 vs. 6.1). As the pH was reduced, the rate of hemoglobin-mediated lipid oxidation of washed cod muscle increased and the lag time prior to TBARS formation decreased (Richards et al., Effect of pH on lipid oxidation using trout hemolysate as a catalyst: A possible role for deoxyhemoglobin. J. Agric. Food Chem. 2000, 48, 3141-3147). Propyl gallate treated washed cod muscle was stable throughout the entire storage period.

TABLE 3
Percent inhibition^{a} of TBARS formation by
cranberry fractions in washed cod muscle^{b}

Concentration
(μmol/kg washed cod)

| Treatment | 37 | 74 |
|---|---|---|
| Fraction 1 | 27.3 ± 1.3 | 71.8 ± 0.7 |
| Fraction 2 | 12.1 ± 4.2 | 41.4 ± 0.9 |
| Fraction 3 | 26.8 ± 9.8 | 56.5 ± 1.4 |
| Fraction 4 | 33.1 ± 2.7 | 64.4 ± 1.2 |
| Fraction 5 | 14.4 ± 0.5 | 15.8 ± 0.9 |
| Fraction 6 | 3.3 ± 1.0 | 10.9 ± 0.2 |

^{a}percent inhibition is determined by the integration the area under the curve on the TBARS formation vs time, [(Area_{control} − Area_{treated})/Area_{control}] * 100
^{b}Trout hemoglobin was added into the system at the final concentration of 12 μmol per kg washed cod. The final pH was between 6.10 and 6.30. All samples were stored at 2° C. for 7 to 9 days.

In this study, proanthocyanidin enriched fraction 5 and 6 (11-16% inhibition at 74 mmole quercetin equivalent) exhibited the weaker inhibition in TBARS formation in washed cod muscle compared to other fractions (41-72% inhibition at 74 mmole quercetin equivalent). In contrast, it has been reported that proanthocyanidin enriched fractions significantly increased the lag time of Cu²⁺-induced LDL oxidation (Porter et al., Cranberry proanthocyanidins associate with low-density lipoprotein and inhibit in vitro Cu²+-induced oxidation. J. Sci. Food Agric. 2001, 81, 1306-1313). However, different oxidation model could have different impact on the antioxidant efficacy of cranberry components. It seems that the degree of polymerization, the nature of the interflavan bond (fraction 5 and 6) and the nature and extent of glycosylation of hydroxyl groups (Fraction 3 and 4) can greatly affect their antioxidant activities in washed cod muscle.

In general, the antioxidant activities of cranberry phenolic fractions in washed cod muscle may be attributed to the free radical scavenging activity resulting from the lower reduction potential of phenolic radicals (Robak et al., Flavonoids Are Scavengers of Superoxide Anions. Biochem. Pharmacol. 1988, 37, 837-841, metal chelating capacity (Morel et al., Antioxidant and Iron-Chelating Activities of the Flavonoids Catechin, Quercetin and Diosmetin on Iron-Loaded Rat Hepatocyte Cultures. Biochem. Pharmacol. 1993, 45, 13-19.), or/and the deactivation of hypervalent heme pigment ferrylmoglobin known to initiate the lipid oxidation (Hu et al., Kinetics of reduction of ferrylmoglobin by (−)-epigallocatechin gallate and green tea extract. J. Agric. Food Chem. 2002, 50, 2998-3003), as well as the content of individual phenolics in each fractions. It has been reported that cranberry juice exhibited scavenging capacity toward active oxygen species such as superoxide, hydroxyl radicals, hydrogen peroxide, and singlet oxygen (Wang et al., Scavenging capacity of berry crops on superoxide radicals, hydrogen peroxide, hydroxyl radicals, and singlet oxygen. J. Agric. Food Chem. 2000, 48, 5677-5684). Because these researchers examined the crude juice, the scavenging capacity of active oxygen species of cranberry juice was likely ascribed to not only phenolic compounds but also ascorbic acid, α-tocopherol, β-carotene and glutathione may be released during storage and initiate the lipid oxidation (St. Angelo, A. J. Lipid oxidation in foods. Crit. Rev. Food Sci. 1996, 36, 175-224). It has also been suggested that the binding of catechin and procyanidins to transferrin may contribute to the antioxidant effect of red wine consumption (Brunet et al., Human apo A-I and rat transferrin are the principal plasma proteins that bind wine catechins. J. Agric. Food Chem. 2002, 50, 2708-2712).

The DPPH scavenging capacity of cranberry fractions was not correlated with the inhibition activity on the lipid oxidation in washed cod muscle. Fraction 6 showed the weakest activity to inhibit lipid oxidation in washed cod muscle but its scavenging activity toward DPPH radicals was highest. On the other hand, fraction 1 showed the strong inhibition on the lipid oxidation in washed cod muscle but its DPPH radical scavenging activity was weakest. Different mechanism of action may explain the discrepancy in the antioxidant efficacy of fractions in the different oxidized systems. DPPH system was conducted in a polar medium (water:ethanol:methanol, 1:1:5, v/v/v) at ambient temperature and without any additional catalyst. In a heterogeneous system such as washed cod muscle, in addition to its structural features, the physical location and orientation of antioxidant in the biomembrane might also play a role on its activity. Moreover, the antioxidant activity of cranberry fractions might be contributed by the ability of flavonoids to modulate the biomembrane fluidity which limits the diffusion of free radicals and inhibit the lipid peroxidation (Arora et al., Modulation of liposomal membrane fluidity by flavonoids and isoflavonoids. Arch. Biochem. Biophys. 2000, 373, 102-109). However, in addition to the intrinsic activity of antioxidant, the interaction of antioxidant and other components in the heterogeneous system will affect its net antioxidant activity in the system. It has been indicated that the interaction between tea flavonoid and milk protein diminished the antioxidant efficacy of flavonoid as a radical scavenging agent toward 2,2′-Azinobis(3-ethylbenzothiazoline-6-sulfonic acid (ABTS) radical (Arts et al., Interactions between flavonoids and proteins: Effect on the total antioxidant capacity. J. Agric. Food Chem. 2002, 50, 1184-1187). The degree of diminishing effect depends on the types of flavonoid and protein.

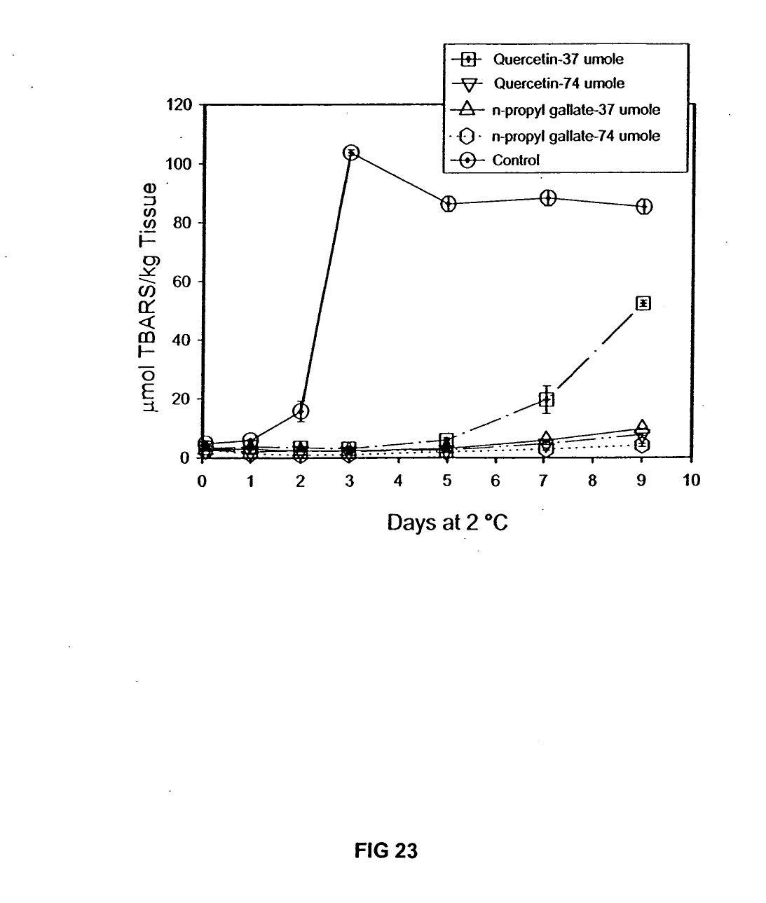

Since fraction 4 was one of the most active fractions, the active components in this fraction were explored. Compared with the retention time and the UV-Vis spectra of standard obtained by reverse phase HPLC analysis described previously, one of the major flavonoid in fraction 4 was tentatively identified as quercetin. It has been reported that flavonol aglycons such as quercetin and myricetin were present in significant amount in the processed concentrated cranberry product (Vvedenskaya et al., Characterization of flavonols in cranberry (Vaccinium macrocarpon) powder. J. Agric. Food Chem. 2004, 52, 188-195). Up to 94% inhibition in TBARS formation was observed in washed cod muscle with 74 mmole quercetin, while 83% inhibition in TBARS formation was shown in washed cod muscle with 37 nimole quercetin. Quercetin (74 mmole) was as effective as 37 mmole propyl gallate in delaying the onset of lipid oxidation and TBARS formation (FIG. 23). Specifically, in referring to FIG. 23, trout hemoglobin was added into the system at the final concentration of 12 and 74 mmol per kg washed cod. The final pH was between 6.20 and 6.30. Also, the results are presented as average±standard deviation from triplicate determinations. These results suggested that quercetin in fraction 4 was a potent inhibitor of hemoglobin-mediated lipid oxidation in washed cod muscle.

### Example 6

### Use of Fruit Components to Preserve Emulsion Systems

The literature has shown phenolic antioxidants, maybe used in preserving the quality of emulsions, oils and creams. For example, it has been described by Jafar et al., that in fish oil mayonnaise, off-odor developed in one day in samples containing no antioxidant system. However, by adding synthetic antioxidants to fish oil mayonnaise the development of off-odor may be delayed. Specifically, by dissolving lipid soluble antioxidants into oil phase and water soluble antioxidants into the aqueous phase prior to forming the emulsion, the shelf life of fish oil mayonnaise was extended by an additional 48 days. (See, Journal of Food Lipids, vol. 1, pp. 295-311 (1994) the entire contents of which have been incorporated by reference herein).

Accordingly, it is encompassed within the present invention that phenolic compounds extracted from fruit may be effective in preserving emulsions to extend shelf life. It is believed that fruit extract antioxidants in crude or substantially purified fractions may be added to the most soluble phase depending on the solubility of the antioxidant (i.e., lipid soluble or water soluble), prior to forming an emulsion. Applicants also believe that the phenolic compounds act by mimicking the hydrogen donating and metal chelating abilities of EDTA, citrate, and ascorbate, thus further inhibiting lipid oxidation and extending shelf life. As described above, the phenolic compounds extracted from fruit, suitably from cranberries may include quercetin, isoquercitrin, cinnamic acid, anthocyanin, flavonoid, or proanthocyanidin and mixtures thereof.

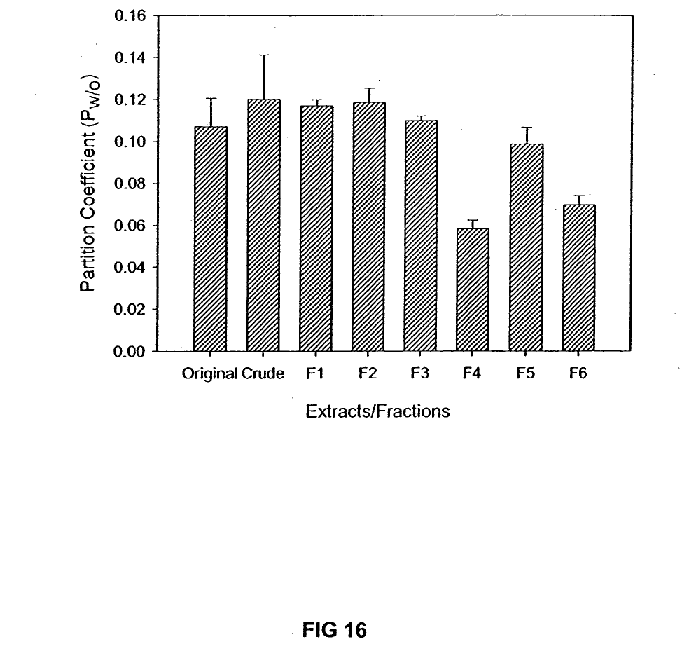

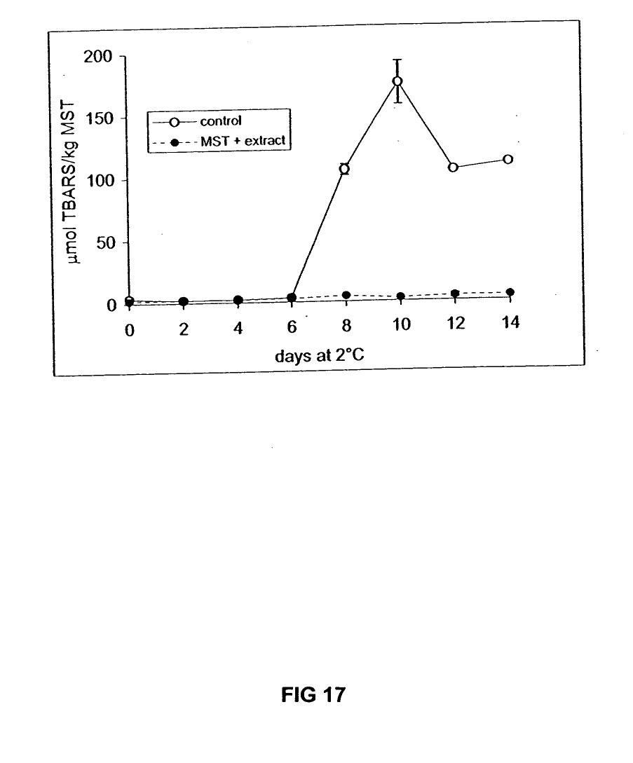

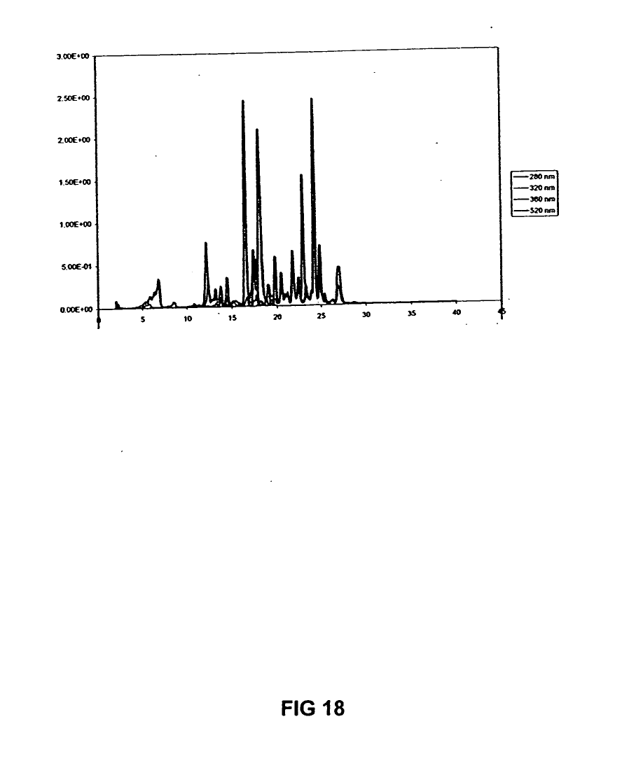

Therefore, in order to evaluate the affect of cranberry components in the preservation of oil and emulsion systems, applicants have performed a number of preliminary studies. Applicants have determined that fraction 4, the most potent fraction appears to be the least soluble in water compared to the other fractions using a model system of oil and water (FIG. 16); which suggested that the antioxidants in Fraction 4 were non-polar. Chloroform which is a non-polar solvent was used to prepare an extract from cranberry powder and was tested in MST. This extract was highly inhibitory when added at 0.01% phenolic compounds (FIG. 17). Separation of phenolic components in the chloroform extract can be seen in FIG. 18. Applicants are currently using high-throughput Flash chromatography system with C18 resin to isolate the compounds in the chloroform extract in more substantial quantities so that the inhibitory component(s) can be determined.

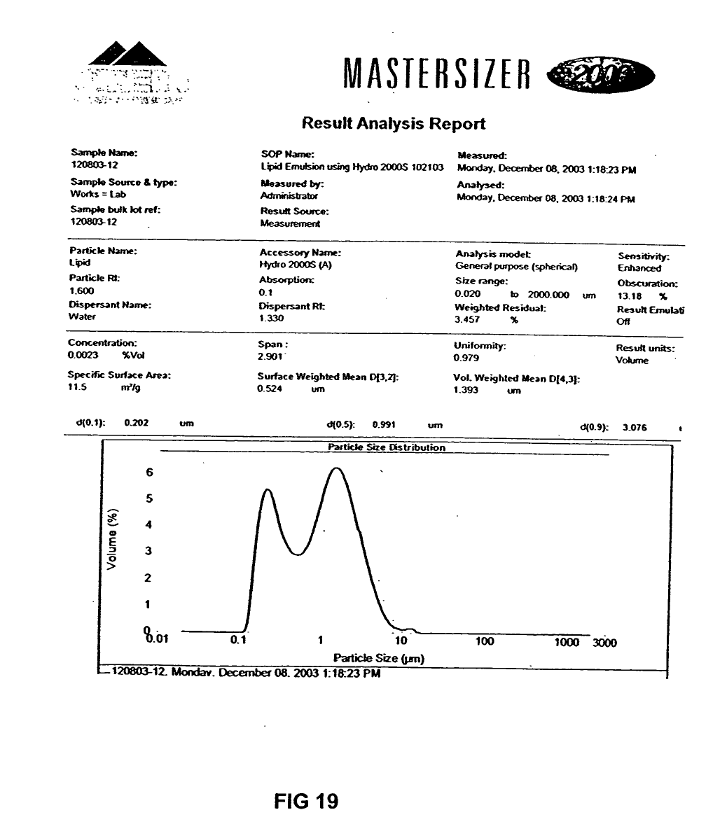

Furthermore, in the efforts to continue to test cranberry antioxidants in emulsion systems, applicants identified an ideal particle size range for distribution in oil-in-water emulsions. However, the primary challenge has been to obtain a uniform particle size in the emulsion droplets. Applicants have now identified a suitable particle size of 0.1 to 0.5 micron, which can be seen in FIG. 19.

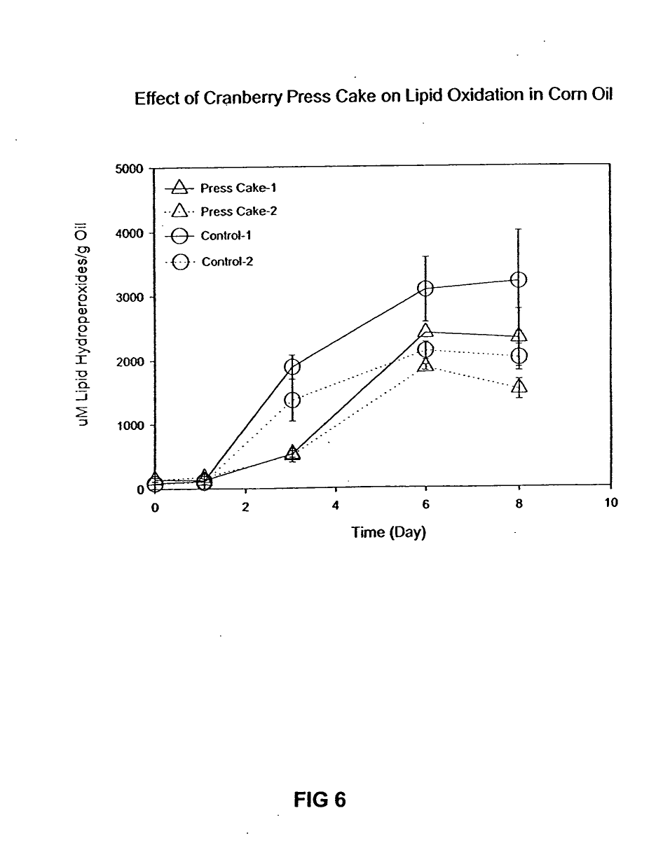

In another study, applicants evaluated the effect of press cake on lipid oxidation in corn oil. Corn oil triglycerides stripped of tocopherols were used in this study. Cranberry press cake was initially extracted by acetone:H₂O(7:3) and the resulting extract was further extracted with ether. Cranberry press cake extract was added into corn oil at the level of 200 ppm. The bulk oil samples were oxidized in a shaker oven at 50° C. It was found that in tocopherol stripped corn oil, an acetone:water and subsequent ether extract from cranberry press cake was capable of delaying lipid peroxide formation (FIG. 6). In referring to FIG. 6, the results are presented as average±standard deviation from triplicate measurements.

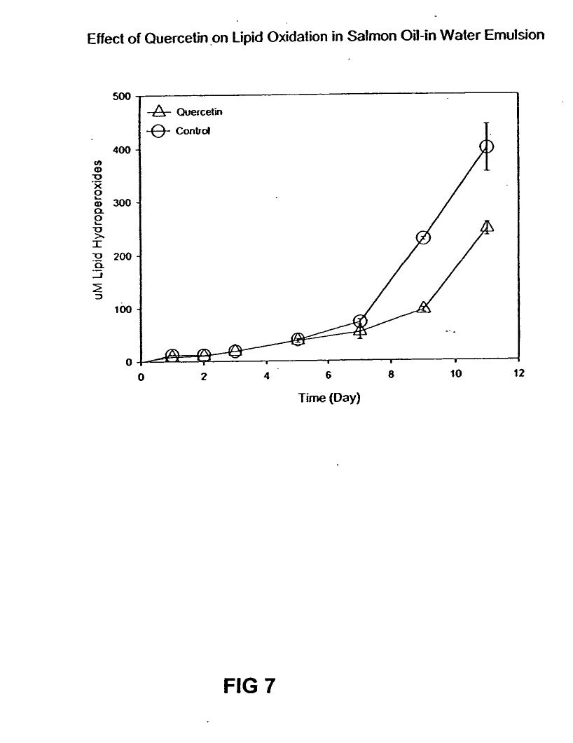

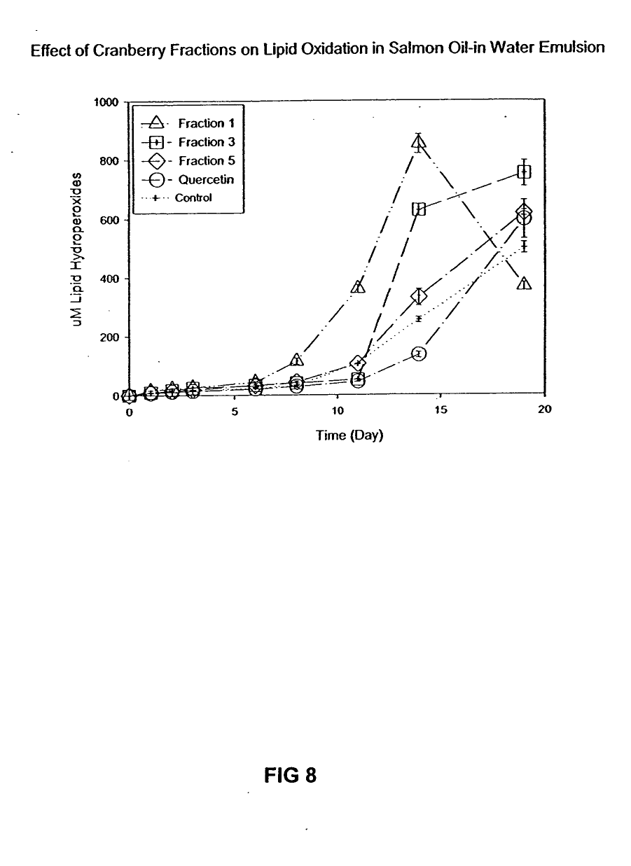

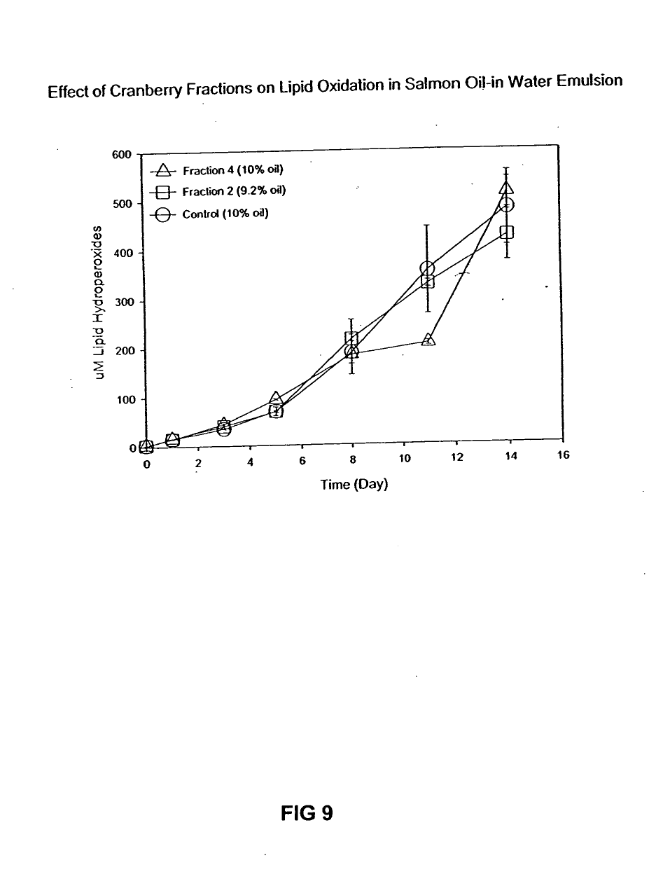

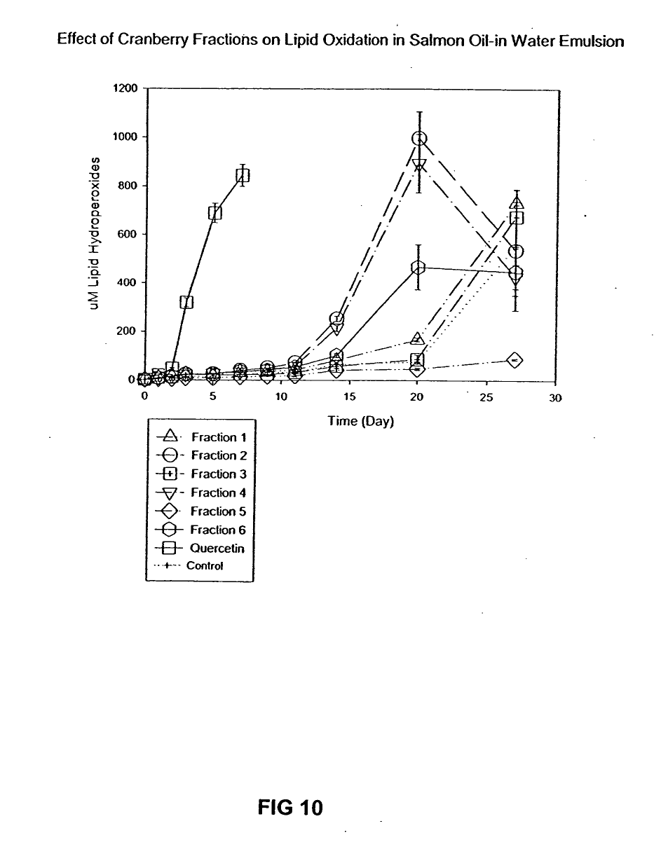

Similarly, applicants have tested cranberry fractions in various emulsion systems (FIGS. 7-0). More specifically, FIG. 7, illustrates the effect of quercetin on lipid oxidation in salmon oil-in water emulsion. The results are presented as average±standard deviation from triplicate measurements. The emulsion consisted of 10% (w/w) salmon oil, 0.5% (w/w) tween 20 and 10 mM pH 3.0 acetate-imidazole buffer. Quercetin was added into the emulsion samples at the level of 400 ppm. The emulsion samples were oxidized in a shaker oven at 27° C. Likewise, FIG. 8, also illustrates the effect of cranberry fractions on lipid oxidation in salmon oil-in water emulsion. However, cranberry fractions and quercetin were added into the emulsion samples at the level of 400 ppm. Also, FIGS. 9 and 10 illustrate the effect of cranberry fractions on lipid oxidation in salmon oil-in water emulsion. However, 10% salmon oil was used in both fraction 4 and control treated samples, whereas 9.2% oil was used in the fraction 2 treated sample.

Applicants observed that in general, fractions 1, 2, 3, 4, and 6 were generally pro-oxidative in emulsion systems or had no effect on rates of lipid oxidation compared to controls. In 2 of 3 trials, quercetin was inhibitory. The results showed that in 1 of 2 trials fraction 5 was inhibitory.

Applicants also note that press cake antioxidants and the potent antioxidants from the chloroform extract of cranberry powder would also be suitable for use in emulsion systems. Furthermore, applicants are also exploring methods to drive cranberry components into the membrane lipids to further increase efficacy of cranberry antioxidants.

### Example 7

### Antioxidant Activities of Cranberry Components in Beef Strip Loin Steaks

In order to evaluate the visual shelf life/color life, surface appearance, lipid oxidation and microbial counts of case ready beef strip loin steaks, we enhanced and topically sprayed Natural Flavor (NF) or topically applied Cranberry Extract (CE) on steaks.

In accordance with the invention, twelve select beef strip loins were split approximately in half and enhanced with a Metalquemia injector to obtain injection gains based on the current target of 8%. The formulation was based on the current beef marinate (water, phosphate, salt and natural flavor). After injection, the primals were cut into steaks, topically sprayed with either natural Flavor (NF) or Cranberry Extract (CE). The topical application rate was 200 ppm for the NJ steaks and 1000 ppm for the CE steaks. The steaks were packaged in a high oxygen atmosphere, aged in dark storage for eleven days then displayed in the shelf life case.

The lean color, fat color and product appearance (sheen) was visually evaluated (a score of “one” is the most desirable). The “display life” was calculated by subtracting the dark storage days from the total saleable days. The total saleable days is the time from packaging until the lean color of the steak is rated five. At the completion of the shelf life evaluation, samples were sent to the Dakota City Lab for microbial (Total Plate Count) and TBA analyses (extraction procedure). Microbial analyses are performed according to accepted enumeration procedures. Data was entered into an Excel spreadsheet and was analyzed with Statgraphics software.

Based on this evaluation, it was determined that the steaks with a topical application of natural flavor (NF) had a significantly longer display life and more desirable lean and fat color scores than the steaks with a topical application of cranberry extract (CE). The CE steaks had a numerically more desirable sheen score and lower TBA value. It is noted that the microbial results (Log Total Plate Count) were not significant. Therefore, it was determined that steaks which were topically sprayed with the natural formulation had a longer display life and more desirable color. However, the dark red color of the topical application of the cranberry extract was unattractive on the steak surface.

TABLE 4
Saleable Display Days, Lean Color Score, Fat Color Score and Surface Appearance
(Sheen) of Beef Strip Loin Steaks by Topical Spray Treatment

| | | | Lean Color | | | | | |
|---|---|---|---|---|---|---|---|---|
| | | | Score^{1,2} | | Fat Color Score^{1,3} | | | |
| Topical | | | (13 days post | | (13 days post | | | |
| Spray | Display Life¹ | | pack) | | pack) | | Sheen Score⁴ | |
| Treatment | (Days ± S.E.) | N | (Score ± S.E.) | n | (Score ± S.E.) | n | (Score ± S.E.) | n |
| Natural | 3.63 ± 0.29^{a} | 3 | 3.86 ± 0.07^{a} | 3 | 1.66 ± 0.12^{a} | 3 | 2.50 ± 0.29 | 8 |
| Flavor (NF) | | 6 | | 6 | | 6 | | |
| Cranberry | 0.32 ± 0.29^{b} | 3 | 4.69 ± 0.07^{b} | 3 | 2.89 ± 0.12^{b} | 3 | 2.25 ± 0.29 | 8 |
| Extract (CE) | | 6 | | 6 | | 6 | | |

¹Means with differing superscripts within a column are significantly different at p ≦ 0.05.
²Lean Color Score: 1 = Bright Cherry Red, 5 = Unsaleable, 7 = Severe Dark Discoloration.
³Fat Color Score: 1 = Bright White, 5 = Severe Gray, Brown or Greenish Discoloration.
⁴Sheen Score: 1 = Dry but may be shiny, 5 = Heavy Gel-like Exudate.

TABLE 5
Microbial Results and TBA Values of Beef Strip
Loin Steaks by Topical Spray Treatment.

| | | |
|---|---|---|
| | | TBA |
| Topical Spray | Log TPC | Mg M/kg |

| Treatment | (Log ± S.E.) | n | (Value ± S.E.) | n |
|---|---|---|---|---|
| Natural Flavor | 7.09 ± 0.27 | 8 | 0.35 ± 0.07 | 8 |
| (NF) | | | | |
| Cranberry | 7.14 ± 0.27 | 8 | 0.26 ± 0.07 | 8 |
| Extract (CE) | | | | |

1 - Means with differing letters within a column indicate significant differences (p ≦ 0.05).

Applicants, also observed that steaks with the cranberry extract spray had a low TBA value. Consequently, it may be beneficial in reducing off-colors and/or off-flavors. The cranberry extract may perform better as injected marinate rather than a topical application. This may also reduce the dark red appearance of the topical application of cranberry extract. It is believed that additional testing may be desirable to determine the optimum application rate and to determine if synergies exist between the current natural flavor and the cranberry extract.

### Example 8

### Effect of Long-Term Feeding with Cranberry Juice Powder on Color Stability of Bacon

In order to evaluate the affects of antioxidant supplements, such as cranberry juice powder on animal diets, Applicants analyzed the effects of high-cranberry diets on quality characteristics of meats that are affected by oxidation reactions. The objective of this study was to compare the parameters, during 14 days of normal refrigerated storage, between bacon samples made from control pigs and pigs fed a 15% cranberry powder diet for six months.

In accordance with the invention, four pigs were randomly assigned to each of two diets: a basal diet supplemented with 5.70% fructose, 4.65% citric acid, 0.73% MgO and 0.23% KCI (control diet) and the basal diet supplemented with 15% Cranberry powder (cranberry diet). After six months of dietary treatment animals were harvested. Muscle pH was evaluated in longissimus muscle 48 hours post-mortem and bacon was made from bellies of each pig. Bacon samples were vacuum packaged and stored under refrigerated conditions (4° C. in the dark) for 10 days. Packages were opened and stored under same conditions until the end of the experiment. The a*, b*, L*, Hue angle and Chroma values were evaluated in lean tissue using a Minolta Chromameter CR-300, everyday from day one to seven and every other day from day eight to fourteen.

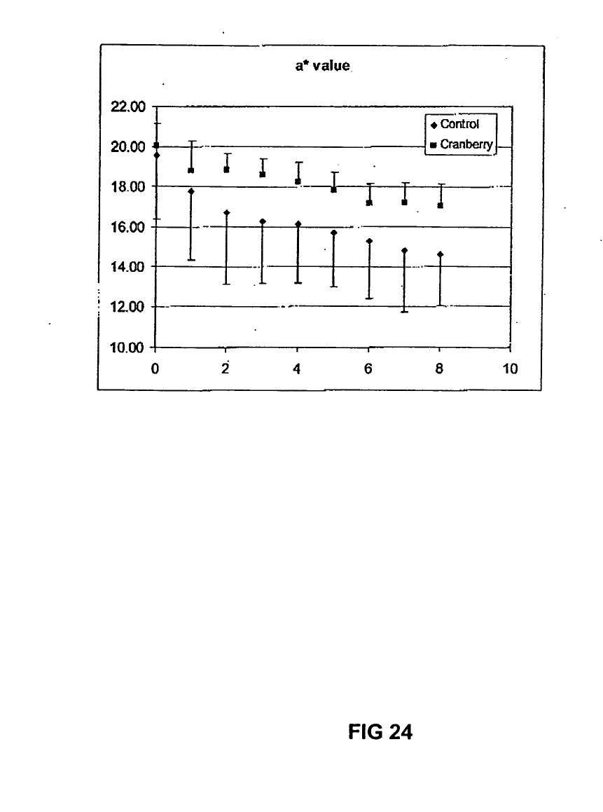

The results of this study (FIG. 24 and Table 6) showed in-part that the pH of longissimus muscle was not different between both diets (5.48±0.11 and 5.44±0.12 for control and cranberry diet, respectively). All the color parameters were significantly affected by time (p<0.01) and there was a significant interaction (p<0.05) between diets and time for all the parameters but I* value.

TABLE 6
Sources of Variants and Probabilities of Significant Effects in Each Color
Parameter Using a Split-Plot-Design.

| | | Pr > F | | | | |
|---|---|---|---|---|---|---|
| Source | DF | a* | b* | L* | Chroma | Hue Angle |
| Treatment | 1 | 0.8425 | 0.6206 | 0.6241 | 0.7661 | 0.3586 |
| Unit (treatment) | 6 | <0.0001 | <0.0001 | <0.0001 | <0.0001 | <0.0001 |
| Time | 1 | <0.0001 | <0.0001 | 0.0028 | <0.0001 | <0.0001 |
| Time * Treatment | 1 | <0.0001 | 0.0103 | 0.2621 | 0.0008 | <0.0001 |

Based on these results, applicants have concluded that long-term feeding with cranberry juice powder alters the time-course changes of most color measurements with the exception of lightness. Bacon from cranberry-fed animals showed a slower decrease in both a* values and Chroma, and a slower increase in both Hue angle and b* values. These results suggest that long-term feeding with cranberry powder may be useful management to delay color deterioration in bacon under normal refrigeration conditions.

### Example 9

### Use of Antioxidant Activities of Cranberry Components to Decrease the Risk of Susceptibility to Various Medical Conditions

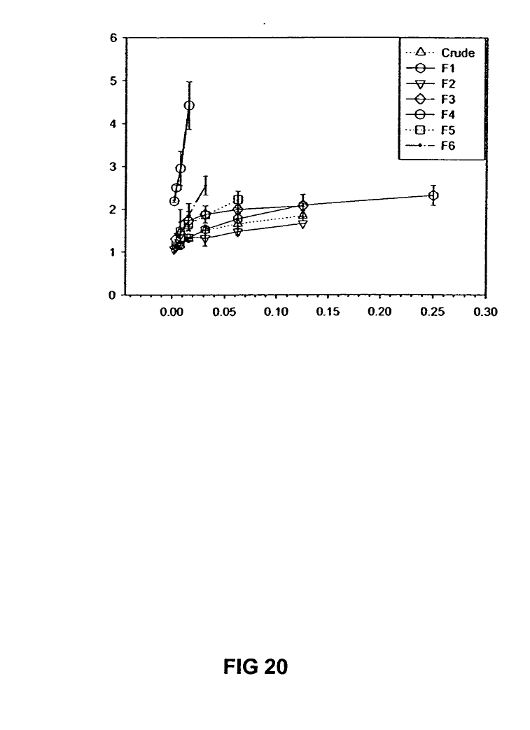

Applicants also envision that the methods of the invention could be used as a readily available and inexpensive approach to decreasing a person's susceptibility to any number of medical conditions, such as for example, cancer. It is well known in the art that an increase in NAD(P)H:quinone reductase activity is associated with decreased risk of various types of cancer [See, e.g., Talalay, Chemoprotection against cancer by induction of phase 2 enzymes. Biofactors (2000) 12, 5-1 1]. It has also been shown that a simple bioassay that assesses the enhancement in activity of this enzyme by different phytochemicals can be used to determine potential health benefits of the phytochemicals being examined. Furthermore, applicants have herein demonstrated that fraction 4 and to a lesser extent fraction 6 from cranberry powder was remarkably effective at boosting reductase activity at very low concentrations (FIG. 20). Accordingly, applicants believe that by incorporating an effective amount of the identified active cranberry fractions or specific components into various products such as, muscle foods, the health benefits of that specific item would be increased. It is believed that persons consuming such types of products or foods could reduce the occurrence or their susceptibility of contracting a variety of medical conditions. Therefore, the industrial applications and health benefits of the methods and compositions of the present invention are fairly extensive, as compared to products that do not contain the disclosed antioxidants.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

1. A method for inhibiting lipid oxidation in a food product susceptible to lipid oxidation, the method comprising:
a) extracting at least one lipophilic antioxidant from a fruit;
b) introducing an effective amount of the extracted antioxidant into the food product;
and
c) inhibiting lipid oxidation in the food product relative to a control food product which is absent of the antioxidant.

2. The method of claim 1 wherein the lipophilic antioxidant is a crude extract.

3. The method of claim 2 wherein the crude extract comprises at least one natural phenolic compound selected from the group consisting of quercetin, isoquercitrin, cinnamic acid, anthocyanin, flavonoid, or proanthocyanidin and mixture thereof.

4. The method of claim 1 wherein the lipophilic antioxidant is a substantially purified compound.

5. The method of claim 4 wherein the substantially purified compound is quercetin.

6. The method of claim 1 wherein the fruit belongs to the genus vaccinium.

7. The method of claim 6 wherein the fruit is selected from the group consisting of blueberry, bilberry, cowberry, cranberry, crowberry, farkleberry, lingonberry, partridgeberry, huckleberry, whortleberry, sparkleberry, bearberry, craneberry, lingonberry, lingberry, bilberry; burren myrtle, dyeberry, hurtleberry, whinberry, or wineberry, and mixture thereof.

8. The method of claim 1 wherein the fruit is selected from the group consisting of cherry, raspberry, blackberry, strawberry, or pomegranate and mixture thereof.

9. The method of claim 1 wherein the fruit is cranberry.

10. The method of claim 1 wherein the food product susceptible to lipid oxidation comprises animal muscle.

11. The method of claim 10 wherein the animal muscle is selected from the group consisting of beef, fish, turkey, poultry, or pork, and mixture thereof.

12. The method of claim 1 wherein the food product susceptible to lipid oxidation is selected from the group consisting of emulsions, oils, or creams.

13. The method of claim 10 wherein the animal muscle is animal feed or pet food.

14. A method for inhibiting lipid oxidation in a food product susceptible to lipid oxidation, the method comprising:
a) extracting at least one lipophilic antioxidant from a fruit;
b) introducing an effective amount of the extracted antioxidant into the food product using an antioxidant carrier to carry the at least one lipophilic antioxidant into a phospholipid membrane; and
c) inhibiting lipid oxidation in the food product relative to a control food product which is absent of the antioxidant.

15. The method of claim 14 wherein the antioxidant carrier is a food-grade carrier.

16. The method of claim 15 wherein the food-grade carrier has a dielectric constant sufficient to carry at least one lipophilic antioxidant into a phospholipid membrane.

17. The method of claim 15 wherein the food-grade carrier is ethanol or propylene glycol.

18. A method of preserving an animal muscle food product, the method comprising:
a) extracting at least one lipophilic antioxidant from a fruit;
b) introducing an effective amount of the extracted antioxidant into the food product; and
c) inhibiting lipid oxidation in the food product relative to a control food product which is absent of the antioxidant, resulting in the preservation of the food product.

19. A method for inhibiting lipid oxidation in a food product susceptible to lipid oxidation, the method comprising:
a) introducing an effective amount of a fruit extract into the food product, wherein the fruit extract is an antioxidant; and
b) inhibiting lipid oxidation in the food product relative to a control food product which is absent of the antioxidant.

20. The method of claim 19 wherein the fruit extract is derived from fruit press cakes or fruit juice.

21. The method of claim 20 wherein the fruit extract comprises a powder or a liquid.

22. The method of claim 17 wherein the fruit is selected from the group consisting of blueberry, bilberry, cowberry, cranberry, crowberry, farkleberry, lingonberry, partridgeberry, huckleberry, whortleberry, sparkleberry, bearberry, craneberry, lingonberry; lingberry, bilberry, burren myrtle, dyeberry, hurtleberry, whinberry, or wineberry and mixture thereof.

23. The method of claim 19 wherein the fruit is selected from the group consisting of cherry, raspberry, blackberry, strawberry or pomegranate and mixture thereof.

24. A method for inhibiting lipid oxidation in a food product susceptible to lipid oxidation, the method comprising:
a) introducing an effective amount of a cranberry fruit powder comprising quercetin into the food product, wherein the food product comprises animal muscle, oil, emulsion, cream or pet food; and
b) inhibiting lipid oxidation in the food product relative to a control food product which is absent of the antioxidant.

25. A composition for inhibiting lipid oxidation in a food product or cosmetic product susceptible to lipid oxidation comprising an effective amount of a natural phenolic compound, isolated from fruit, wherein the compound is selected from the group consisting of quercetin, isoquercitrin, cinnamic acid, anthocyanin, flavonoid, or proanthocyanidin and mixture thereof.

26. The composition of claim 25 wherein the compound is in the form of a powder or liquid.

27. The composition of claim 25 wherein the fruit is selected from the group consisting of blueberry, bilberry, cowberry, cranberry, crowberry, farkleberry, lingonberry, partridgeberry, huckleberry, whortleberry, sparkleberry, bearberry, craneberry, lingonberry; lingberry, bilberry, burren myrtle, dyeberry, hurtleberry, whinberry, or wineberry and mixture thereof.

28. The composition of claim 25 wherein the fruit is selected from the group consisting of cherry, raspberry, blackberry, strawberry or pomegranate and mixture thereof.

29. The composition of claim 25 wherein the fruit is cranberry.

30. The composition of claim 25 wherein the food product comprises animal muscle, emulsion, oil, cream, or pet food.

31. An edible composition comprising at least one natural phenolic compound extracted from fruit and introduced into a food product or cosmetic product susceptible to lipid oxidation, wherein the fruit is a cranberry.

32. The composition of claim 31 wherein the compound is quercitin.

33. The composition of claim 31 wherein at least one natural phenolic compound is introduced into the products by an antioxidant carrier.
